(19) United States
(12) Patent Application Publication
(10) Pub. No.: US 2026/0222120 A1
(43) Pub. Date: Jul. 30, 2026

(54) DEVICES, METHODS, AND MEDIUM FOR COMMUNICATION

(71) Applicant: NEC Corporation, Tokyo (JP)

(72) Inventors: Lei CHEN, Beijing (CN); Gang WANG, Beijing (CN)

(73) Assignee: NEC Corporation, Tokyo (JP)

(21) Appl. No.: 19/143,444

(22) PCT Filed: Dec. 28, 2022
(86) PCT No.: PCT/CN2022/142978

§ 371 Date: Jun. 26, 2025

(51) Int. Cl. H04L 1/1812; H04W 72/20

(52) U.S. Cl. CPC H04L 1/1812; H04W 72/20

(57) ABSTRACT

Example embodiments of the present disclosure relate to devices, methods, and computer storage medium for communication. A terminal device receives CG information indicating multiple configured CG occasions in a CG period from a network device. The terminal device determines an integer value associated with a hyper system frame if the CG period is across two hyper system frames or starts in a new hyper system frame. The terminal device determines multiple HARQ process numbers of the multiple configured CG occasions based on at least one of: a number of the multiple configured CG occasions, or a current symbol number determined based on the integer value. The terminal device performs an uplink transmission to the network device based on the multiple HARQ process numbers. As such, a current symbol number may be determined based on an integer value associated with a hyper system frame, an SFN wrap around issue is considered and accordingly the determination of the HARQ process number may be ensured to be more accurate. Therefore, the efficiency of a communication between the terminal device and the network device may be improved.

### FIELD

Example embodiments of the present disclosure generally relate to the field of communication techniques and in particular, to devices, methods, and a computer readable medium for communication.

### BACKGROUND

Recently, a new work item on the enhancements for extended reality (XR) services is ongoing in new radio (NR) release 18 (Rel-18). To better support the XR services, enhancement on power saving and capacity will be studied and specified.

Configured grant (CG) physical uplink shared channel (PUSCH) is beneficial for meeting some requirements of the XR services since no scheduling request (SR) and buffer status report (BSR) reporting is needed. However, the enhancement of CG PUSCH is further to be studied.

### SUMMARY

In general, example embodiments of the present disclosure provide devices, methods, and a computer storage medium for communication.

In a first aspect, there is provided a terminal device. The terminal device comprises at least one processor configured to cause the terminal device at least to: receive, from a network device, CG information indicating a plurality of configured CG occasions in a CG period; determine whether the CG period is across two hyper system frames or starts in a new hyper system frame; in accordance with a determination that the CG period is across two hyper system frames or starts in a new hyper system frame, determine an integer value associated with a hyper system frame; determine a plurality of hybrid automatic repeat request (HARQ) process numbers of the plurality of configured CG occasions based on at least one of: a number of the plurality of configured CG occasions, or a current symbol number determined based on the integer value; and perform an uplink transmission to the network device based on the plurality of HARQ process numbers.

In a second aspect, there is provided a terminal device. The terminal device comprises at least one processor configured to cause the terminal device at least to: receive, from a network device, CG information indicating a plurality of configured CG occasions in a CG period; determine at least one used CG occasion and/or at least one unused CG occasion from the plurality of configured CG occasions; determine a first HARQ process number of a first configured CG occasion among the plurality of configured CG occasions; and transmit, to the network device, uplink control information (UCI) associated with at least the first configured CG occasion, the UCI comprising at least one of: a first number of the at least one used CG occasion, a second number of the at least one unused CG occasion, a first index of a last used CG occasion among the at least one used CG occasion, a second index of a first unused CG occasion among the at least one unused CG occasion, or a HARQ process indication indicating at least the first HARQ process number.

In a third aspect, there is provided a terminal device. The terminal device comprises at least one processor configured to cause the terminal device at least to: receive, from a network device, CG information indicating a plurality of configured CG occasions in a CG period; and transmit, to the network device, a UCI associated with a configured CG occasion among the plurality of configured CG occasions, the UCI comprising a presence indication indicating whether an uplink shared channel is transmitted in the configured CG occasion.

In a fourth aspect, there is provided a network device. The network device comprises at least one processor configured to cause the network device at least to: transmit, to a terminal device, CG information indicating a plurality of configured CG occasions in a CG period; determine whether the CG period is across two hyper system frames or starts in a new hyper system frame; in accordance with a determination that the CG period is across two hyper system frames or starts in a new hyper system frame, determine an integer value associated with a hyper system frame; determine a plurality of HARQ process numbers of the plurality of configured CG occasions based on at least one of: a number of the plurality of configured CG occasions, or a current symbol number determined based on the integer value; and receive an uplink transmission from the terminal device based on the plurality of HARQ process numbers.

In a fifth aspect, there is provided a network device. The network device comprises at least one processor configured to cause the network device at least to: transmit, to a terminal device, CG information indicating a plurality of configured CG occasions in a CG period; and receive, from the terminal device, a UCI associated with at least a first configured CG occasion, the UCI comprising at least one of: a first number of at least one used CG occasion among the plurality of configured CG occasions, a second number of at least one unused CG occasion among the plurality of configured CG occasions, a first index of a last used CG occasion among the at least one used CG occasion, a second index of a first unused CG occasion among the at least one unused CG occasion, or a HARQ process indication indicating at least a first HARQ process number of the first configured CG occasion.

In a sixth aspect, there is provided a network device. The network device comprises at least one processor configured to cause the network device at least to: transmit, to a terminal device, CG information indicating a plurality of configured CG occasions in a CG period; and receive, from the terminal device, a UCI associated with a configured CG occasion among the plurality of configured CG occasions, the UCI comprising a presence indication indicating whether an uplink shared channel is transmitted in the configured CG occasion.

In a seventh aspect, there is provided a method of communication. The method comprises: receiving, at a terminal device from a network device, CG information indicating a plurality of configured CG occasions in a CG period; determining whether the CG period is across two hyper system frames or starts in a new hyper system frame; in accordance with a determination that the CG period is across two hyper system frames or starts in a new hyper system frame, determining an integer value associated with a hyper system frame; determining a plurality of HARQ process numbers of the plurality of configured CG occasions based on at least one of: a number of the plurality of configured CG occasions, or a current symbol number determined based on the integer value; and performing an uplink transmission to the network device based on the plurality of HARQ process numbers.

In an eighth aspect, there is provided a method of communication. The method comprises: receiving, at a terminal device from a network device, CG information indicating a plurality of configured CG occasions in a CG period; determining at least one used CG occasion and/or at least one unused CG occasion from the plurality of configured CG occasions; determining a first HARQ process number of a first configured CG occasion among the plurality of configured CG occasions; and transmitting, to the network device, a UCI associated with at least the first configured CG occasion, the UCI comprising at least one of: a first number of the at least one used CG occasion, a second number of the at least one unused CG occasion, a first index of a last used CG occasion among the at least one used CG occasion, a second index of a first unused CG occasion among the at least one unused CG occasion or a HARQ process indication indicating at least the first HARQ process number.

In a ninth aspect, there is provided a method of communication. The method comprises: receiving, at a terminal device from a network device, CG information indicating a plurality of configured CG occasions in a CG period; and transmitting, to the network device, a UCI associated with a configured CG occasion among the plurality of configured CG occasions, the UCI comprising a presence indication indicating whether an uplink shared channel is transmitted in the configured CG occasion.

In a tenth aspect, there is provided a method of communication. The method comprises: transmitting, at a network device to a terminal device, CG information indicating a plurality of configured CG occasions in a CG period; determining whether the CG period is across two hyper system frames or starts in a new hyper system frame; in accordance with a determination that the CG period is across two hyper system frames or starts in a new hyper system frame, determining an integer value associated with a hyper system frame; determining a plurality of HARQ process numbers of the plurality of configured CG occasions based on at least one of: a number of the plurality of configured CG occasions, or a current symbol number determined based on the integer value; and receiving an uplink transmission from the terminal device based on the plurality of HARQ process numbers.

In an eleventh aspect, there is provided a method of communication. The method comprises: transmitting, at a network device to a terminal device, CG information indicating a plurality of configured CG occasions in a CG period; and receiving, from the terminal device, a UCI associated with at least a first configured CG occasion, the UCI comprising at least one of: a first number of at least one used CG occasion among the plurality of configured CG occasions, a second number of at least one unused CG occasion among the plurality of configured CG occasions, a first index of a last used CG occasion among the at least one used CG occasion, a second index of a first unused CG occasion among the at least one unused CG occasion, or a HARQ process indication indicating at least a first HARQ process number of the first configured CG occasion.

In a twelfth aspect, there is provided a method of communication. The method comprises: transmitting, at a network device to a terminal device, CG information indicating a plurality of configured CG occasions in a CG period; and receiving, from the terminal device, a UCI associated with a configured CG occasion among the plurality of configured CG occasions, the UCI comprising a presence indication indicating whether an uplink shared channel is transmitted in the configured CG occasion.

In a thirteenth aspect, there is provided a computer readable medium having instructions stored thereon, the instructions, when executed on at least one processor, causing the at least one processor to carry out the method according to any one of the seventh to the twelfth aspects above.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates a signalling chart illustrating communication process in accordance with some embodiments of the present disclosure;

FIG. 3A illustrates a schematic diagram of multiple configured CG occasions in a CG period in accordance with some embodiments of the present disclosure;

FIG. 3B illustrates a schematic diagram of multiple HARQ process numbers in accordance with some embodiments of the present disclosure;

FIG. 3C illustrates a schematic diagram of a CG period with an SFN wrap around issue in accordance with some embodiments of the present disclosure;

FIG. 4 illustrates a signalling chart illustrating communication process in accordance with some embodiments of the present disclosure;

FIG. 5A illustrates a schematic diagram of the association between a UCI and a configured CG occasion in accordance with some embodiments of the present disclosure;

FIG. 5B illustrates a schematic diagram of the association between a UCI and a used CG occasion in accordance with some embodiments of the present disclosure;

FIG. 6 illustrates a signalling chart illustrating communication process in accordance with some embodiments of the present disclosure;

FIG. 7 illustrates a schematic diagram of the association between a UCI and a CG occasion in accordance with some embodiments of the present disclosure;

FIG. 8 illustrates a flowchart of an example method implemented at a terminal device in accordance with some embodiments of the present disclosure;

FIG. 9 illustrates a flowchart of an example method implemented at a terminal device in accordance with some embodiments of the present disclosure;

FIG. 10 illustrates a flowchart of an example method implemented at a terminal device in accordance with some embodiments of the present disclosure;

FIG. 11 illustrates a flowchart of an example method implemented at a network device in accordance with some embodiments of the present disclosure;

FIG. 12 illustrates a flowchart of an example method implemented at a network device in accordance with some embodiments of the present disclosure;

FIG. 13 illustrates a flowchart of an example method implemented at a network device in accordance with some embodiments of the present disclosure; and

FIG. 14 illustrates a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, enhancement on power saving and capacity of XR services are to be studied. There are some important features of the XR traffic which are quite different from other serveries, for example:
Jitter of packet arrival time: for a downlink (DL) or uplink (UL) video stream, there is a significant jitter effect for the data packet arrival time. This means, the packet can arrive to the gNB or UE at any time within a specific range, e.g., [−4 ms, 4 ms], around a theoretically average arrival time.
Delay budget: transmission of the video and pose/control packets with low latency is very critical for XR service to provide good user experience, therefore a very stringent requirement of delay budget is needed, e.g., 10 ms, 15 ms, etc.
Large and varying packet size: for a high quality video stream, a video frame usually has a large size, e.g., around 1M bits per frame after compression for a video stream. In addition, the data packet size is varying over time, it is difficult to predict the packet size before it arrives.

CG PUSCH is beneficial for meeting the stringent delay budget since no SR and BSR reporting is needed. However, the large and variable packet size should be considered in the enhancement of CG PUSCH.

It is agreed that multiple CG PUSCH transmission occasions may be supported in a period of a single CG PUSCH configuration. There are two types of transmission without dynamic grant: configured grant Type 1 where an uplink grant is provided by radio resource control (RRC) and stored as configured uplink grant; and configured grant Type 2 where an uplink grant is provided by physical downlink control channel (PDCCH), and stored or cleared as configured uplink grant based on layer 1 (L1) signalling indicating configured uplink grant activation or deactivation.

Type 1 and Type 2 are configured by RRC for a Serving Cell per bandwidth part (BWP). Multiple configurations can be active simultaneously in the same BWP. For Type 2, activation and deactivation are independent among the Serving Cells. For the same BWP, the medium access control (MAC) entity can be configured with both Type 1 and Type 2.

After an uplink grant is configured for a configured grant Type 1, the MAC entity shall consider sequentially that the Nth (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = ( timeReferenceSFN \times numberOfSlotsPerFrame \times numberOfSymbolsPerSlot + timeDomainOffset \times numberOfSymbolsPerSlot + S + N \times periodicity ) modulo ( 1024 \times numberOfSlotsPerFrame \times numberOfSymbolsPerSlot ) , \qquad ( equation 1 )$$

wherein S is derived from SLIV or provided by RRC configuration startSymbol; timeReferenceSFN refers to the system frame number (SFN) used for determination of the offset of a resource in time domain and UE uses the closest SFN with the indicated number preceding the reception of the configured grant configuration.

After an uplink grant is configured for a configured grant Type 2, the MAC entity shall consider sequentially that the Nth (N>=0) uplink grant occurs in the symbol for which:

$$[ ( SFN \times numberOfSlotsPerFrame \times numberOfSymbolsPerSlot ) + ( slot number in the frame \times numberOfSymbolsPerSlot ) + symbol number in the slot ] = [ ( SFNstart time \times numberOfSlotsPerFrame \times numberOfSymbolsPerSlot + slotstart time \times numberOfSymbolsPerSlot + symbolstart time ) + N \times periodicity ] modulo ( 1024 \times numberOfSlotsPerFrame \times numberOfSymbolsPerSlot ) \qquad ( equation 2 )$$

where SFNstart time, slotstart time, and symbolstart time are the SFN, slot, and symbol, respectively, of the first transmission opportunity of PUSCH where the configured uplink grant was (re-)initialized.

It is known that CG PUSCH is beneficial for XR services, however, some further issues of the CG PUSH, such as a determination of a HARQ process number, are still to be studied.

Embodiments of the present disclosure provide a solution of communication. In the solution, a terminal device may receive CG information indicating multiple configured CG occasions from a network device. The terminal device may further determine a HARQ process number for corresponding configured CG occasions based on an integer value associated with a hyper system frame. As such, an SFN wrap around issue is considered and accordingly the determination of the HARQ process number may be ensured to be more accurate. Therefore, the efficiency of a communication between the terminal device and the network device may be improved. Principles and implementations of the present disclosure will be described in detail below with reference to the figures.

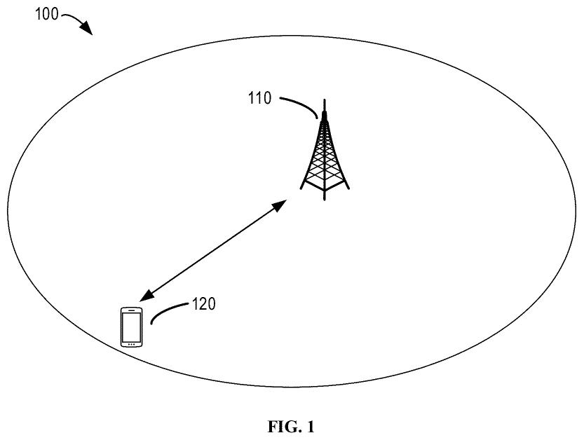

FIG. 1 illustrates an example communication system 100 in which some embodiments of the present disclosure can be implemented. The communication network 100 includes a network device 110 and a terminal device 120. The network device 110 can provide services to the terminal device 120.

In the system 100, it is assumed that the terminal device 120 is located within coverage of the network device 110. In some examples, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). In some embodiments, the network device 110 and the terminal device 120 may communicate with direct links/channels. DL may comprise one or more logical channels, including but not limited to a Physical Downlink Control Channel (PDCCH) and a Physical Downlink Shared Channel (PDSCH). UL may comprise one or more logical channels, including but not limited to a Physical Uplink Control Channel (PUCCH) and a Physical Uplink Shared Channel (PUSCH). As used herein, the term “channel” may refer to a carrier or a part of a carrier consisting of a contiguous set of resource blocks (RBs) on which a channel access procedure is performed in shared spectrum.

Communications in the system 100, between the network device 110 and the terminal device 120 for example, may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

It is to be understood that the numbers of devices (i.e., the network device 110 and the terminal device 120) and their connection relationships and types shown in FIG. 1 are only for the purpose of illustration without suggesting any limitation. The system 100 may include any suitable numbers of devices adapted for implementing embodiments of the present disclosure.

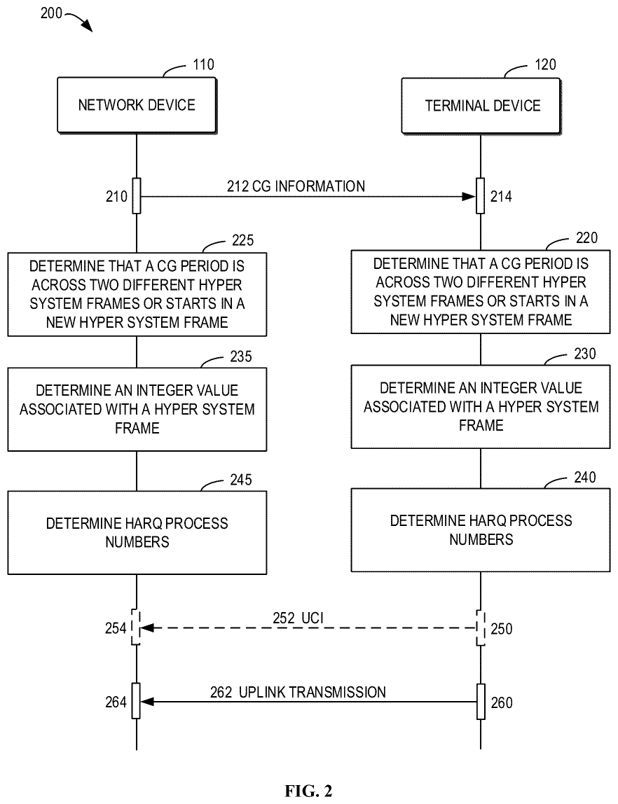

Reference is further made to FIG. 2, which illustrates a signalling chart illustrating communication process 200 in accordance with some example embodiments of the present disclosure. Only for the purpose of discussion, the process 200 will be described with reference to FIG. 1. The process 200 may involve the network device 110 and the terminal device 120.

The network device 110 transmits 210 CG information 212 to the terminal device 120. In some example embodiments, the CG information 212 may indicate multiple configured CG occasions in a CG period. In some examples, the number of the multiple configured CG occasions may be represented as Ncg, which may be an integer greater than 0. For example, 1≤Ncg≤8. It is to be understood that the value of Ncg may be any integer and the present disclosure does not limit this aspect. In other words, the CG information 212 may indicate that there are Ncg configured CG occasions per CG period.

In some example embodiments, the CG information 212 may indicate a type 1 CG. In some examples, the CG information 212 may include a CG configuration, for example, the CG information may be transmitted via an RRC message/signalling.

In some example embodiments, the CG information 212 may indicate a type 2 CG. In some examples, the CG information 212 may be transmitted via an RRC message/signalling or may be transmitted via downlink control information (DCI). In some example, the DCI may be used to activate the multiple configured CG occasions in a CG period.

In some examples, the CG information 212 may further indicate a reference system frame number (SFN), for example, the reference SFN may have same definition as the “timeReferenceSFN” in equation 1 above. In some examples, the CG information 212 may further indicate an SFN start time, for example, the SFN start time may have same definition of the “SFNstart time” in equation 2 above. The detailed description of the reference SFN or the SFN start time will be discussed below.

Accordingly, the network device 110 may indicate to the terminal device 120 that a CG period comprises Ncg configured CG occasions. On the other side of communication, the terminal device 120 receives 214 the CG information 212. The terminal device 120 may determine Ncg configured CG occasions in a CG period based on the CG information 212.

In the present disclosure, a configured CG occasion may refer to a transmission occasion for a CG PUSCH. For example, a configured CG occasion may occupy multiple time units, where a time unit may be a symbol, a slot, a sub-frame, a frame, etc.

The terminal device 120 may determine whether a CG period is across two hyper system frames or starts in a new hyper system frame. As shown in FIG. 2, the terminal device 120 determines 220 that the CG period is across two hyper system frames or starts in a new hyper system frame.

It is understood that the SFN may be indexed from 0 to 1023 in NR, and the time duration from the start of SFN 0 to the end of SFN 1023 may refer to a hyper system frame or an SFN period. In other words, a hyper system frame includes 1024 system frames with SFN 0-1023. After the end of SFN 1023, the value of SFN gets back to 0 and a new hyper system frame (or a new SFN period) is started.

Since a periodicity of the CG period may be any value, it is to be understood that an SFN wrap around issue may exist, for example, if some new integer or non-integer number of periodicity is introduced.

In some examples, a CG period may be across two different hyper system frames, for example, a CG period may be partially overlapped with SFN 1023 of a first hyper system frame and partially overlapped with SFN 0 of a second hyper system frame after the first hyper system frame. In some examples, a CG period may be started in a new hyper system frame, for example, a CG period may end in SFN 1023 of a first hyper system frame, and a next CG period may start in SFN 0 of a second hyper system frame after the first hyper system frame, in other words, the next CG period is started in a new hyper system frame.

A CG period may be a time duration with a length of Tp, where Tp is determined based on the CG information, e.g., based on the indication of a periodicity. A CG period may be started from the start of the first configured CG occasion in the CG period, or it may be started from a time offset before the start of the first configured CG occasion in the CG period. Alternatively, the start time of a CG period is determined based on the reference SFN or the SFN start time.

If the terminal device 120 determines that the CG period is across two hyper system frames or the CG period starts in a new hyper system frame, the terminal device 120 determines 230 an integer value associated with a hyper system frame. For example, the integer values may be different for different hyper system frames. In some examples, the integer value may be represented as Msfn, which may be used to determine a HARQ process number of a configured CG occasion.

The terminal device 120 determines 240 multiple HARQ process numbers of the multiple configured CG occasions. In some examples, a HARQ process number may also be referred to as a HARQ process ID. In some example embodiments, for each CG period, the terminal device 120 may determine multiple HARQ process numbers of the multiple configured CG occasions in the CG period. In some examples, a HARQ process number is determined based on a number of the multiple configured CG occasions (Ncg) and/or a current symbol number determined based on the integer value Msfn. For example, the current symbol number may also be called as a current symbol index, and may be represented as “CURRENT_symbol”.

In some example embodiments, for each of Ncg configured CG occasions, the terminal device 120 may determine a corresponding HARQ process number. In some examples, for the Tth configured CG occasion (where T=0, 1, . . . , Ncg-1) among the Ncg configured CG occasions in a CG period, the HARQ process number of the Tth configured CG occasion may be determined (or calculated) based on the following equation 3 or equation 4:

$$HARQ Process ID = [ floor ( CURRENT\_symbol / periodicity ) \times Ncg + T ] modulo nrofHARQ - Processes \qquad ( equation 3 )$$

$$HARQ Process ID = [ floor ( CURRENT\_symbol / periodicity ) \times Ncg + T ] modulo nrofHARQ - Processes + harq\_offset \qquad ( equation 4 )$$

In some example embodiments, floor (x) may refer to a function for determining an integer not larger than x, modulo (or represented as “mod”) may refer to a function for determining a remainder when one integer is divided by another. In some example embodiments, periodicity may refer to a time duration of a period. In some example embodiments, nrofHARQ-Processes may refer to a configured maximum number of HARQ processes. In some example embodiments, harq_offset may be an integer value, for example, the value of harq_offset may be configured by the network device 110.

In some example embodiments, CURRENT_symbol may refer to a symbol index and it may be determined by:

$$CURRENT\_symbol = ( SFN \times numberOfSlotsPerFrame \times numberOfSymbolsPerSlot + slot number in the frame \times numberOfSymbolsPerSlot + symbol number in the slot ) , \qquad ( equation 5 )$$

where numberOfSlotsPerFrame refers to a total number of consecutive slots per frame, numberOfSymbolsPerSlot refers to a total number of consecutive symbols per slot. In some examples, CURRENT_symbol may be determined based on one of the following options: option 1 and option 2.

Option 1: CURRENT_symbol refers to the symbol index of the first symbol of the first configured CG occasion of the Ncg configured CG occasions. Specifically, SFN, slot number in the frame, and symbol number in the slot in equation 5 may be determined based on the first configured CG occasion of the Ncg configured CG occasions. It is understood that the first configured CG occasion is used for determining the HARQ process number, and thus the backward compatibility may be achieved by the present disclosure.

Option 2: CURRENT_symbol refers to the symbol index of the first symbol of the Tth configured CG occasion of the Ncg configured CG occasions. Specifically, SFN, slot number in the frame, and symbol number in the slot in equation 5 may be determined based on the Tth configured CG occasion of the Ncg configured CG occasions.

In some example embodiments, an SFN wrap around issue may exist, for example, a specific CG period may include a first part in a first hyper system frame and a second part in a second (i.e., next) hyper system frame. In this case, there may be some confliction of the HARQ process number among the Ncg configured CG occasions in the CG period, or there may be some confliction of the HARQ process number between a configured CG occasion in a CG period and another configured CG occasion in the next CG period. In this event, the SFN wrap around issue may be considered and CURRENT_symbol may be determined by:

$$CURRENT\_symbol = [ ( 1024 \times Msfn + SFN ) \times numberOfSlotsPerFra me \times numberOfSymbolsPerSlot + slot number in the frame \times numberOfSymbolsPerSlot + symbol number in the slot ] \qquad ( equation 6 )$$

Based on equation 6, CURRENT_symbol may be determined based on an integer value which is associated with a hyper system frame. In some examples, while determining a HARQ process number of a specific configured CG occasion (such as the Tth configured CG occasion), the terminal device 120 may determine which hyper system frame is related to the specific configured CG occasion, and further determine the integer value of the hyper system frame. For example, a hyper system frame including the first symbol of the first configured CG occasion may be determined. For another example, a hyper system frame including the first symbol of the specific configured CG occasion (such as the Tth configured CG occasion) may be determined. In some example embodiments, SFN, slot number in the frame, and symbol number in the slot in equation 6 may be determined based on option 1 or option 2 as discussed above.

In some examples, the integer value may be represented as Msfn which is an integer number associated with a hyper system frame. In some examples, CURRENT_symbol may be determined further based on a length of a hyper system frame. For example, the length of the hyper system frame is represented as 1024 in equation 6, since a hyper system frame including 1024 system frames.

In some example embodiments, the integer value may be configured with an initial value, such as a predefined value. For example, the predefined value may equal to 0 or may be another value preconfigured by the network device 110. In some examples, the integer value may be determined as the predefined value at the start of a system frame with a reference SFN or an SFN start time. Specifically, the CG information 212 above may indicate the reference SFN or the SFN start time, accordingly, the terminal device 120 may determine the reference SFN or the SFN start time based on the CG information 212. If the terminal device 120 determine that the system frame with an SFN equals to the reference SFN (represented as timeReferenceSFN and for type 1 CG) or the SFN start time (represented as SFNstart time and for type 2 CG), then the integer value may be determined as the predefined value. In some other cases, the integer value may be updated by incrementing 1 at the beginning of a new hyper system frame. In other words, the integer value is incremented by 1 when a new hyper system frame starts, i.e., every time the SFN gets back to 0 again, in other words, at the beginning of a system frame with an SFN equals to 0.

In some other example embodiments, the integer value may be a hyper system frame number (HSFN). In some examples, while determining a HARQ process number of a specific configured CG occasion (such as the Tth configured CG occasion), the terminal device 120 may determine which hyper system frame is related to the specific configured CG occasion, and further determine the HSFN of the hyper system frame. For example, a hyper system frame including the first symbol of the first configured CG occasion may be determined. For another example, a hyper system frame including the first symbol of the specific configured CG occasion (such as the Tth configured CG occasion) may be determined. In some examples, the terminal device 120 may obtain the HSFN from system information which is transmitted from the network device110. In some other examples, the HSFN may be configured by the network device110, and the terminal device 120 may determine the HSFN based on a configuration from the network device110.

Therefore, equation 6 may be used for determining CURRENT_symbol, which may be used for determining the HARQ process number based on equation 3 or equation 4. In some examples, the multiple HARQ process numbers for the multiple configured CG occasions are continuous. For example, one of the multiple HARQ process numbers may be one of values 0 to nrofHARQ-Processes-1.

Further refer to FIG. 2, the network device 110 may determine 225 that the CG period is across two hyper system frames or starts in a new hyper system frame. The network device 110 determines 235 an integer value associated with a hyper system frame, and determines 245 multiple HARQ process numbers of the multiple configured CG occasions in the CG period. It is understood that the operations at the network device 110 may be similar with that at the terminal device 120, and thus will not be repeated herein.

Additionally or alternatively, the terminal device 120 may determine at least one used CG occasion and/or at least one unused CG occasion from the multiple configured CG occasions. In some example embodiments, the terminal device 120 may determine a number of required CG occasions as the at least one used CG occasion after the arrival of an uplink data burst. In some example embodiments, the terminal device 120 may determine the at least one used CG occasion based on the size of the uplink data burst and resource allocation information, for example, the resource allocation information may include an amount of allocated resource elements (REs) for each configured CG occasion, modulation and coding scheme (MCS) for each configured CG occasion, etc.

In some example embodiments, the at least one used CG occasion may include more than one used CG occasion, and the more than one used CG occasion may be continuous in the multiple configured CG occasions. In some examples, the more than one used CG occasion may be started from the first one among the multiple configured CG occasions. However, it is to be appreciated that in some other cases, the more than one used CG occasion may be not continuous, or the more than one used CG occasion may be started from any one of the multiple configured CG occasions, the present disclosure does not limit this aspect.

In some examples, the Tth configured CG occasion among the Ncg configured CG occasion may be determined as a used CG occasion or an unused CG occasion. For example, the terminal device 120 may determine that the Tth configured CG occasion is one of the at least one unused CG occasion. If the Tth configured CG occasion is an unused CG occasion, the terminal device 120 does not expect to receive a DCI scheduling a retransmission with a HARQ process number same with the Tth configured CG occasion.

In some examples, the Tth configured CG occasion may have at least one OFDM symbol overlapping with an unavailable resource, and the terminal device 120 may determine not to use the Tth configured CG occasion. In some examples, the unavailable resource may include one or more of: a downlink symbol, a flexible symbol indicated by a slot format indication (SFI), or a symbol used by the network device 110. For example, the terminal device 120 may determine that the Tth configured CG occasion is one of the at least one unused CG occasion. For example, the terminal device 120 may determine that the Tth configured CG occasion is neither one of the at least one used CG occasion nor one of the at least one unused CG occasion. If the Tth configured CG occasion is overlapped with an unavailable resource, the terminal device 120 does not expect to receive a DCI scheduling a retransmission with a HARQ process number same with the Tth configured CG occasion.

Additionally or alternatively, as shown in FIG. 2, the terminal device 120 may transmit 250 uplink control information (UCI) 252 to the network device 110.

In some example embodiments, the UCI may be associated with a used CG occasion, for example, the UCI may be transmitted on a PUCCH associated with a used CG occasion; for another example, the UCI may be transmitted in the used CG occasion, that is, the UCI may be a CG-UCI.

In some example embodiments, the UCI may indicate a first number of the at least one used CG occasion. For example, the terminal device 120 may determine the at least one used CG occasion in a CG period, and further determine the total number of the at least one used CG occasion as the first number.

In some example embodiments, the UCI may indicate a second number of the at least one unused CG occasion. For example, the terminal device 120 may determine the at least one unused CG occasion in a CG period, and further determine the total number of the at least one unused CG occasion as the second number. In some examples, if the Tth configured CG occasion is overlapped with an unavailable resource, the Tth configured CG occasion may be not a used CG occasion, in some cases, the Tth configured CG occasion may be one of the at least one unused CG occasion, and the Tth configured CG occasion may be counted into the second number; in some other cases, the Tth configured CG occasion may be not one of the at least one unused CG occasion, and the Tth configured CG occasion may not be counted into the second number.

In some example embodiments, the UCI may indicate a first index of the last used CG occasion among the at least one used CG occasion. In some examples, the at least one used CG occasion may include more than one continuous used CG occasion, and the UCI may indicate the index of the last one of the at least one used CG occasion.

In some example embodiments, the UCI may indicate a second index of the first unused CG occasion among the at least one unused CG occasion. In some examples, the at least one unused CG occasion may include more than one unused CG occasion, and the UCI may indicate the index of the first one of the at least one unused CG occasion.

In some example embodiments, the UCI may include a HARQ process indication (HPI) to indicate a HARQ process number of a configured CG occasion.

On the other side of communication, the network device 110 may receive 254 the UCI 252. In some example embodiments, the network device 110 may determine one or more of the following based on the UCI 252: a first number of at least one used CG occasion, a second number of at least one unused CG occasion, a first index of the last used CG occasion among the at least one used CG occasion, or a second index of the first unused CG occasion among the at least one unused CG occasion.

In some example embodiments, the UCI 252 includes an HPI, and the network device 110 may determine the HARQ process number based on the HPI. For example, the HPI is used to determine the HARQ process number of an associated CG occasion based on one or more of: a number of the multiple configured CG occasions in a CG period, a first number of the at least one used CG occasion, a second number of the at least one unused CG occasion, or whether the associated CG occasion is overlapped with an unavailable resource.

The terminal device 120 transmits 260 an uplink transmission 262 to the network device 110. Specifically, the uplink transmission 262 may be a CG PUSCH (or UL-SCH) in the at least one used CG occasion. On the other side of communication, the network device 110 receives 264 the uplink transmission 262.

Additionally or alternatively, the network device 110 may further transmit a DCI to the terminal device 120, where the DCI is used to indicate the terminal device 120 to retransmit with an indicated HARQ process number determined based on the UCI 252.

In some example embodiments, the network device 110 may determine a HARQ process number for retransmission. For example, the HARQ process number of a configured CG occasion overlapping with an unavailable resource may be not used.

The terminal device 120 may receive the DCI, and may further perform an uplink retransmission based on the DCI. In some examples, the terminal device 120 may determine one used CG occasion with a HARQ process number equals to the indicated HARQ process number in the DCI, and the terminal device 120 may retransmit a UL-SCH in the one used CG occasion.

As such, the retransmission of CG PUSCH can be scheduled based on the HARQ process number when it is necessary, therefore the communication reliability can be enhanced.

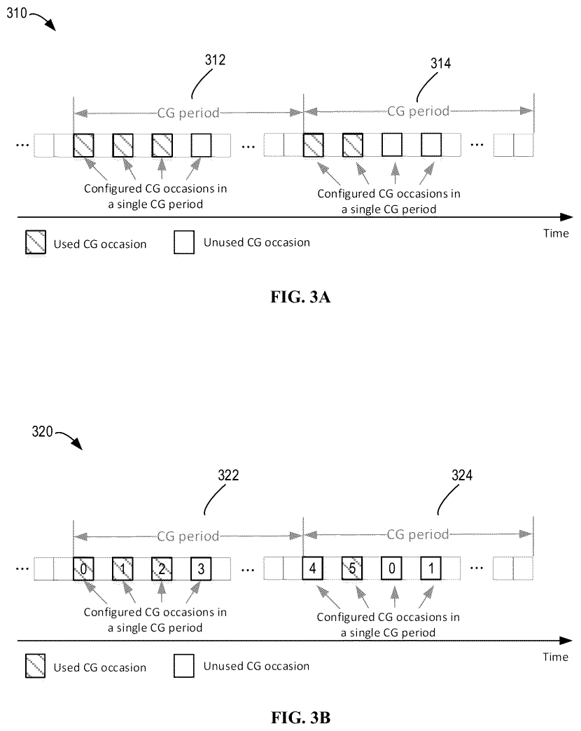

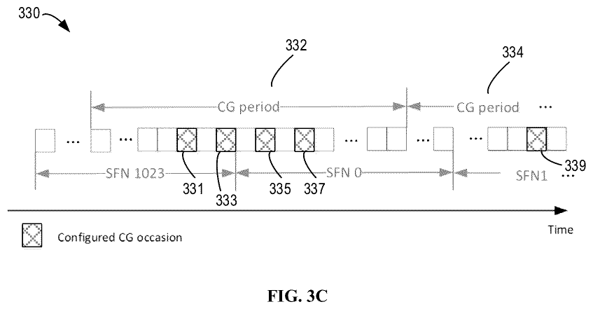

FIG. 3A illustrates a schematic diagram 310 of multiple configured CG occasions in a CG period in accordance with some embodiments of the present disclosure. As shown in FIG. 3A, there are Ncg=4 configured CG occasions per CG period. The terminal device 120 may determine at least one used CG occasion and at least one unused CG occasion. As shown in FIG. 3A, it is assumed that the terminal device 120 determines 3 used CG occasions in the CG period 312 and 2 used CG occasions in the CG period 314. Specifically, the first 3 configured CG occasions in the CG period 312 are used CG occasions, and the first 2 configured CG occasions in the CG period 314 are used CG occasions.

FIG. 3B illustrates a schematic diagram 320 of multiple HARQ process numbers in accordance with some embodiments of the present disclosure. As shown in FIG. 3B, there are 4 configured CG occasions per CG period. It is assumed that Ncg=4 and nrofHARQ-Processes=6. The terminal device 120 may determine that the multiple HARQ process numbers for the multiple configured CG occasions are continuous. A HARQ process number of a configured CG occasion may equal to a HARQ process number of its previous CG occasion plus 1, modulo nrofHARQ-Processes if needed. A shown in FIG. 3B, the HARQ process numbers are 0, 1, 2, 3, 4, 5, 0, 1, . . . respectively. The terminal device 120 may determine at least one used CG occasion and at least one unused CG occasion. As shown in FIG. 3B, it is assumed that the terminal device 120 determines 3 used CG occasions in the CG period 322 with HARQ process numbers 0-2, and 1 used CG occasion in the CG period 324 with a HARQ process number 5.

FIG. 3C illustrates a schematic diagram 330 of a CG period with an SFN wrap around issue in accordance with some embodiments of the present disclosure. A CG period 332 and part of a CG period 334 are shown in FIG. 3C, and some example configured CG occasions 331 to 339 are shown in FIG. 3C. A shown in FIG. 3C, the CG period 332 include a first part in a first hyper system frame (i.e., SFN 1023) and a second part in a second hyper system frame (i.e., SFN 0).

In some examples, if option 2 is used for determining CURRENT_symbol in equation 5 for determining the HARQ process number, there may be some confliction of the HARQ process number among Ncg configured CG occasions in a CG period. For example, the SFN number for the first two CG occasions 331 and 333 and the last two CG occasions 335 and 337 may be not continuous, and it is possible that one of the first two CG occasions 331 and 333 and one of the last two CG occasions 335 and 337 may have a same HARQ process number is option 2 is used.

In some examples, although option 1 for determining CURRENT_symbol in equation 5 may avoid confliction among Ncg configured CG occasions in a CG period, there may be still a confliction issue between two consecutive CG periods, such as CG periods 332 and 334. For example, SFN values used for the two CG periods 332 and 334 are 1023 and 1 respectively, and it is possible that some of the configured CG occasions in the two CG periods 332 and 334 may have a same HARQ process number.

In the case as shown in FIG. 3C, equation 6 discussed above may be used for determining CURRENT_symbol, which can be used to determine the HARQ process number based on equation 3 or equation 4. As such, the SFN wrap around issue may be considered and the confliction of HARQ process number may be solved.

It is understood that some examples are shown in FIGS. 3A-3C only for the purpose of illustration without suggesting any limitation as to the scope of the disclosure, some other examples may also be applied and the present disclosure does not list herein for brevity.

According to the example embodiments described with reference to FIGS. 2-3C, HARQ process numbers for each of multiple configured CG occasions may be determined based on a number of the multiple configured CG occasions and a symbol index of current symbol which may be associated with a hyper system frame. As such, an SFN wrap around issue may be considered while determining the HARQ process number, a confliction of the HARQ process number may be avoided, and accordingly the communication between the terminal device and the network device may be guaranteed. Additionally, at least one used/unused CG occasion may be determined and indicated by UCI, and the resource of the unused CG occasion(s) may be re-allocated to other terminal device(s) by the network device 110, it is beneficial for resource efficiency.

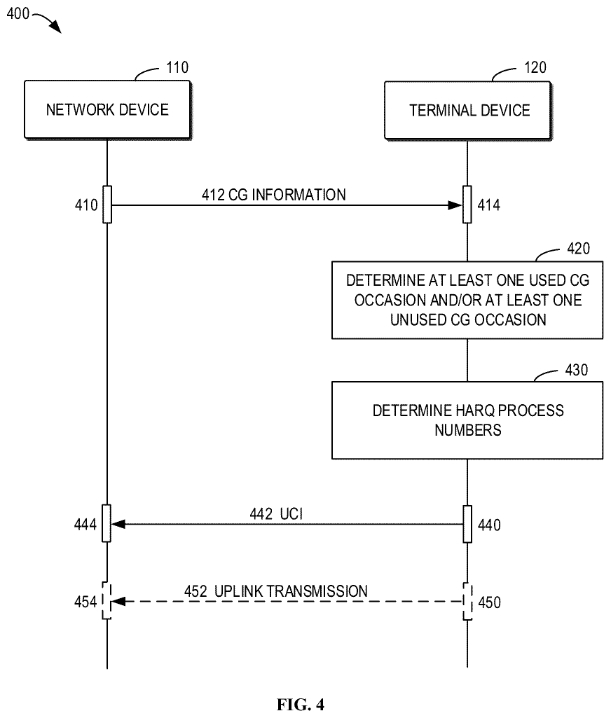

Reference is further made to FIG. 4, which illustrates a signalling chart illustrating communication process 400 in accordance with some example embodiments of the present disclosure. Only for the purpose of discussion, the process 400 will be described with reference to FIG. 1. The process 400 may involve the network device 110 and the terminal device 120.

The network device 110 transmits 410 CG information 412 to the terminal device 120. In some example embodiments, the CG information 412 may indicate multiple configured CG occasions in a CG period. In some examples, the number of the multiple configured CG occasions may be represented as Ncg, which may be an integer greater than 0. For example, 1≤Ncg≤8. It is to be understood that the value of Ncg may be any integer and the present disclosure does not limit this aspect. In other words, the CG information 412 may indicate that there are Ncg configured CG occasions per CG period.

In some example embodiments, the CG information 412 may indicate a type 1 CG. In some examples, the CG information 412 may include a CG configuration, for example, the CG information may be transmitted via an RRC message/signalling.

In some example embodiments, the CG information 412 may indicate a type 2 CG. In some examples, the CG information 412 may be transmitted via an RRC message/signalling or may be transmitted via downlink control information (DCI). In some example, the DCI may be used to activate the multiple configured CG occasions in a CG period.

Accordingly, the network device 110 may indicate to the terminal device 120 that a CG period comprises Ncg configured CG occasions. On the other side of communication, the terminal device 120 receives 414 the CG information 412. The terminal device 120 may determine Ncg configured CG occasions in a CG period based on the CG information 412.

In the present disclosure, a configured CG occasion may refer to a transmission occasion for a CG PUSCH. For example, a configured CG occasion may occupy multiple time units, where a time unit may be a symbol, a slot, a sub-frame, a frame, etc.

The terminal device 120 determines 420 at least one used CG occasion and/or at least one unused CG occasion from the multiple configured CG occasions. The terminal device 120 determines 430 at least a first HARQ process number of a first configured CG occasion among the multiple configured CG occasions. The terminal device 120 transmits 440 a UCI 442 to the network device 110. In some example embodiments, the UCI 442 may be associated with the first configured CG occasion in a CG period. In some other example embodiments, for each of the at least one used CG occasion, an associated UCI 442 may be transmitted, that is, at least one UCI may be transmitted associated with the at least one used CG occasion.

In some example embodiments, the terminal device 120 may determine a number of required CG occasions as the at least one used CG occasion after the arrival of an uplink data burst. In some example embodiments, the terminal device 120 may determine the at least one used CG occasion based on the size of the uplink data burst and resource allocation information, for example, the resource allocation information may include an amount of allocated REs for each configured CG occasion, MCS for each configured CG occasion, etc.

In some example embodiments, the at least one used CG occasion may include more than one used CG occasion, and the more than one used CG occasion may be continuous in the multiple configured CG occasions. In some examples, the more than one used CG occasion may be started from the first one among the multiple configured CG occasions. However, it is to be appreciated that in some other cases, the more than one used CG occasion may be not continuous, or the more than one used CG occasion may be started from any one of the multiple configured CG occasions, the present disclosure does not limit this aspect.

In some examples, the Tth configured CG occasion among the Ncg configured CG occasion may be determined as a used CG occasion or an unused CG occasion. For example, the terminal device 120 may determine that the Tth configured CG occasion is one of the at least one unused CG occasion. If the Tth configured CG occasion is an unused CG occasion, the terminal device 120 does not expect to receive a DCI scheduling a retransmission with a HARQ process number same with the Tth configured CG occasion.

In some examples, the Tth configured CG occasion may have at least one OFDM symbol overlapping with an unavailable resource, and the terminal device 120 may determine not to use the Tth configured CG occasion. In some examples, the unavailable resource may include one or more of: a downlink symbol, a flexible symbol indicated by an SFI, or a symbol used by the network device 110. For example, the terminal device 120 may determine that the Tth configured CG occasion is one of the at least one unused CG occasion. For example, the terminal device 120 may determine that the Tth configured CG occasion is neither one of the at least one used CG occasion nor one of the at least one unused CG occasion. If the Tth configured CG occasion is overlapped with an unavailable resource, the terminal device 120 does not expect to receive a DCI scheduling a retransmission with a HARQ process number same with the Tth configured CG occasion.

In some example embodiments, the UCI 442 may indicate the at least one used CG occasion and/or the at least one unused CG occasion in the CG period. For example, the UCI 442 may include an indication field carrying one or more of: a first number of at least one used CG occasion, a second number of at least one unused CG occasion, a first index of the last used CG occasion among the at least one used CG occasion, or a second index of the first unused CG occasion among the at least one unused CG occasion.

For example, the first number may be a value from 1 to Ncg (e.g., CG-UCI), or a value from 0 to Ncg (e.g., UCI on PUCCH). For example, the second number may be a value from 0 to Ncg-1 (e.g., CG-UCI), or a value from 0 to Ncg (e.g., UCI on PUCCH). For example, it is assumed that the multiple configured CG occasions have indexes 0 to Ncg-1 respectively. For example, the first index may be a value from 1 to Ncg-1 (e.g., CG-UCI), or a value from 0 to Ncg-1 (e.g., UCI on PUCCH). It is understood that if the first index is 0 (e.g., UCI on PUCCH), it means all the configured CG occasions are unused CG occasions. For example, the second index may be a value from 1 to Ncg (e.g., CG-UCI), or a value from 0 to Ncg (e.g., UCI on PUCCH). It is understood that if the second index is Ncg, it means all the configured CG occasions are used CG occasions.

In some examples, there may be a preconfigured or predefined minimum number to indicate a minimum number of used CG occasions. In some examples, the preconfigured or predefined minimum number may be a parameter of the minimum number of used CG occasions, the parameter can be denoted by Nmin, which is less than or equal to Ncg. For example, the parameter may be configured by the network device 110.

In some examples, if the UCI 424 indicates a first number of at least one used CG occasion, the first number may be greater than or equal to the preconfigured or predefined minimum number. For example, the first number may be a value from Nmin to Ncg. In some examples, if the UCI 424 indicates a second number of at least one unused CG occasion, the second number may be less than or equal to a difference of Ncg and the preconfigured or predefined minimum number. For example, the first number may be a value from 0 to Ncg-Nmin.

In some examples, it is assumed that the multiple configured CG occasions have indexes 0 to Neg-1 respectively. In some examples, if the UCI 424 indicates a first index of the last used CG occasion, the first index may be greater than or equal to the preconfigured or predefined minimum number minus 1. For example, the first index may be a value from Nmin-1 to Ncg-1. In some examples, if the UCI 424 indicates a second index of the first unused CG occasion, the second index may be greater than or equal to the preconfigured or predefined minimum number. For example, the second index may be a value from Nmin to Ncg. The second index being Ncg may indicate that all configured CG occasions are used CG occasions.

Alternatively, if the size of traffic packets is not enough to transmit UL-SCHs in all the Nmin CG occasions, for a CG occasion of the first Nmin CG occasions, the terminal device 120 may not transmit a CG PUSCH if there is no UL-SCH to be transmitted, i.e., the data in the buffer is completely transmitted. Alternatively, if the size of traffic packets is not enough to transmit UL-SCHs in all the Nmin CG occasions, for a CG occasion of the first Nmin CG occasions, the terminal device 120 may retransmit a UL-SCH which is already transmitted in one of the first Nmin CG occasions. For example, the terminal device 120 may retransmit the most recent UL-SCH, or may determine a UL-SCH based on the index of the CG occasion, e.g., if Nmin=4, and two UL-SCHs are transmitted in the first two CG occasions and all data are completely transmitted, then the terminal device 120 may retransmit the first and second UL-SCHs in the third and fourth CG occasions, respectively.

In some example embodiments, the UCI 442 may be associated with the first configured CG occasion or be associated with a CG period. The UCI 442 may be transmitted as a CG-UCI or a UCI transmitted on a PUCCH associated with the first configured CG occasion. In some examples, the network device 110 may configure a PUCCH resource associated with the first configured CG occasion, for example, based on a time offset between the PUCCH and the first configured CG occasion. The terminal device 120 may transmit the UCI 442 on the configured PUCCH resource. In some examples, the configured CG occasions other than the first configured CG occasion may have no associated UCI to be transmitted.

In some examples, the UCI 442 may further include a HARQ process indication (HPI) to indicate the first HARQ process number of the first configured CG occasion among the multiple configured CG occasions. For example, the first HARQ process number is determined based on a number of the multiple configured CG occasions (Ncg) and a symbol index of the first symbol in the first configured CG occasion, CURRENT_symbol a discussed above. In some examples, the terminal device 120 may determine the first HARQ process number of the first configured CG occasion in a similar way that described with reference to FIG. 2, for example equation 3 or equation 4 may be referred to determine the first HARQ process number.

In some examples, the HPI may indicate an integer number which can be denoted by K, it is understood that K is an integer between 0 and nrofHARQ-Processes-1. The HPI may indicate that the first HARQ process number of the first configured CG occasion is K or K+harq_offset (refer to equation 4 above).

The terminal device 120 may further determine a HARQ process number of a further configured CG occasion. For example, the terminal device 120 may determine a second HARQ process number of a second configured CG occasion as the first HARQ process number plus 1, where the second configured CG occasion is closest to the first configured CG occasion and after the first configured CG occasion. In some examples, the terminal device 120 may determine the HARQ process number by incrementing 1 for each subsequent used CG occasion in a scheduled order, with modulo operation of nrofHARQ-Processes applied. For example, for the Qth configured CG occasion, its HARQ process number may be [(K+Q) modulo nrofHARQ-Processes] or [(K+Q) modulo nrofHARQ-Processes+harq_offset].

In some examples, the terminal device 120 may determine HARQ process number for each of used CG occasions, or for each of used or unused CG occasions. For example, the Tth configured CG occasion may have at least one OFDM symbol overlapping with an unviable resource, in this case, the HARQ process number is not incremented by 1.

In some examples, a used CG occasion for retransmission or repetition may have a HARQ process number the same as the used CG occasion for the first transmission. In other words, if a UL-SCH transmitted in a used CG occasion is a retransmission or a repetition, the HARQ process number of the used CG occasion is not incremented by 1, and is equal to the HARQ process number of another used CG occasion for the first transmission.

In some other example embodiments, for each used CG occasion, the terminal device 120 may transmit an associated UCI to the network device 110. In some examples, the UCI may be a CG-UCI, or may be a UCI transmitted on a PUCCH associated with the used CG occasion. The terminal device 120 transmits 440 UCI 442 on each used CG occasion or on each PUCCH associated with each used CG occasion. In some examples, for a configured CG occasion overlapping with an unavailable resource, the associated UCI may be not transmitted. For example, the configured CG occasion overlapping with an unavailable resource may be an unused CG occasion, or may be neither a used nor an unused CG occasion.

In some examples, each UCI may include an HPI to indicate the HARQ process number of the associated CG occasion. In some examples, an HPI may indicate an integer number which can be denoted by K, it is understood that K is an integer between 0 and nrofHARQ-Processes-1. The HPI may indicate that the HARQ process number of the associated CG occasion is K or K+harq_offset (refer to equation 4 above). For example, a UCI associated with a first used CG occasion may include a first HPI indicating a first HARQ process number of the first used CG occasion, and a UCI associated with a second used CG occasion may include a second HPI indicating a second HARQ process number of the second used CG occasion.

In some examples, the terminal device 120 may determine each HARQ process number for each of the at least one used CG occasion. For example, the terminal device 120 may determine the HARQ process numbers continuously. For example, if a HARQ process number of a used CG occasion is K, then the HARQ process number of the subsequent used CG occasion may be [(K+1) modulo nrofHARQ-Processes] or [(K+1) modulo nrofHARQ-Processes+harq_offset], where the two adjacent used CG occasions may be in a same CG period or in different CG periods.

On the other side of communication, the network device 110 receives 444 the UCI 442. The network device 110 may determine at least one used CG occasion and/or at least one unused CG occasion in the CG period. The network device 110 may further determine the HARQ process number of each of the at least one used CG occasion based on the UCI 442.

Further referring to FIG. 4, the terminal device 120 may transmit 450 an uplink transmission 452 to the network device 110. Specifically, the uplink transmission 452 may be a CG PUSCH (or UL-SCH) in the at least one used CG occasion. On the other side of communication, the network device 110 may receive 454 the uplink transmission 452.

Additionally or alternatively, the network device 110 may further transmit a DCI to the terminal device 120, where the DCI is used to indicate the terminal device 120 to retransmit with an indicated HARQ process number determined based on the UCI 442. The terminal device 120 may receive the DCI, and may further perform an uplink retransmission based on the DCI. In some examples, the terminal device 120 may determine one used CG occasion with a HARQ process number equals to the indicated HARQ process number in the DCI, and the terminal device 120 may retransmit a UL-SCH in the one used CG occasion.

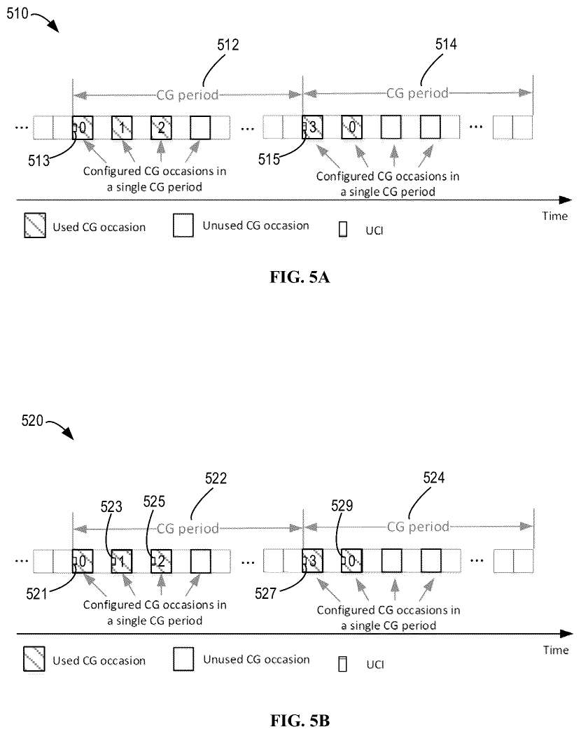

FIG. 5A illustrates a schematic diagram 510 of the association between a UCI and a configured CG occasion in accordance with some embodiments of the present disclosure. It is assumed that Ncg=4 and nrofHARQ-Processes=4. As shown in FIG. 5A, there are 4 configured CG occasions per CG period. A UCI may be a CG-UCI, which may be transmitted in the first configured CG occasion in a CG period.

The terminal device 120 may determine at least one used CG occasion and at least one unused CG occasion. The terminal device 120 may further determine the HARQ process number for each of the at least one used CG occasion. As shown in FIG. 5A, it is assumed that the terminal device 120 determines 3 used CG occasions in the CG period 512 with HARQ process numbers 0-2, and 2 used CG occasions in the CG period 514 with HARQ process numbers 3 and 0.

As an example, a UCI 513 transmitted in the first configured CG occasion in the CG period 512 may include: an indication that the unused CG occasion number is 1, and an HPI that the HARQ process number of the first configured CG occasion in the CG period 512 is 0. A UCI 515 transmitted in the first configured CG occasion in the CG period 514 may include: an indication that the unused CG occasion number is 2, and an HPI that the HARQ process number of the first configured CG occasion in the CG period 514 is 3.

It is understood that the network device 110 may receive the UCI 513, and the network device 110 may determine that there is 1 unused CG occasion in the CG period 512 and the HARQ process number of the first configured CG occasion is 0. The network device 110 may further determine that there are 3 used CG occasions in the CG period 512. The network device 110 may further determine the HARQ process number of the second configured CG occasion in the CG period 512 is 0+1=1, and the HARQ process number of the third configured CG occasion in the CG period 512 is 1+1=2.

FIG. 5B illustrates a schematic diagram 520 of the association between a UCI and a used CG occasion in accordance with some embodiments of the present disclosure. It is assumed that Ncg=4 and nrofHARQ-Processes=4. As shown in FIG. 5B, there are 4 configured CG occasions in each CG period. A UCI may be a CG-UCI, which may be transmitted in each of the used CG occasions in a CG period.

The terminal device 120 may determine at least one used CG occasion and at least one unused CG occasion. The terminal device 120 may further determine the HARQ process number for each of the at least one used CG occasion. As shown in FIG. 5B, it is assumed that the terminal device 120 determines 3 used CG occasions in the CG period 522 with HARQ process numbers 0-2, and 2 used CG occasions in the CG period 524 with HARQ process numbers 3 and 0.

As an example, UCI 521, 523, 525, 527, or 529 may be transmitted in the associated used CG occasion. Each of UCI 521, 523 and 525 in CG period 522 may include an indication that the unused CG occasion number is 1. Additionally, UCI 521, 523, and 525 each further includes an HPI indicating that the HARQ process number of the associated CG occasion is 0, 1, and 2 respectively. Each of UCI 527 and 529 in CG period 524 may include an indication that the unused CG occasion number is 2. Additionally, UCI 527 and 529 each further includes an HPI indicating that the HARQ process number of the associated CG occasion is 3, and 0 respectively.

It is understood that some examples are shown in FIGS. 5A-5B only for the purpose of illustration without suggesting any limitation as to the scope of the disclosure, for example, the UCI may be not a CG-UCI but a UCI on an associated PUCCH, some other examples may also be applied and the present disclosure does not list herein for brevity.

According to the example embodiments described with reference to FIGS. 4-5B, at least one used/unused CG occasion may be determined and indicated by UCI, and the resource of the unused CG occasion(s) may be re-allocated to other terminal device(s) by the network device 110, it is beneficial for resource efficiency. Additionally, a HARQ process number may be indicated by the UCI, the retransmission of the CG PUSCH may be scheduled when it is necessary based on the HARQ process number, therefore the reliability can be enhanced.

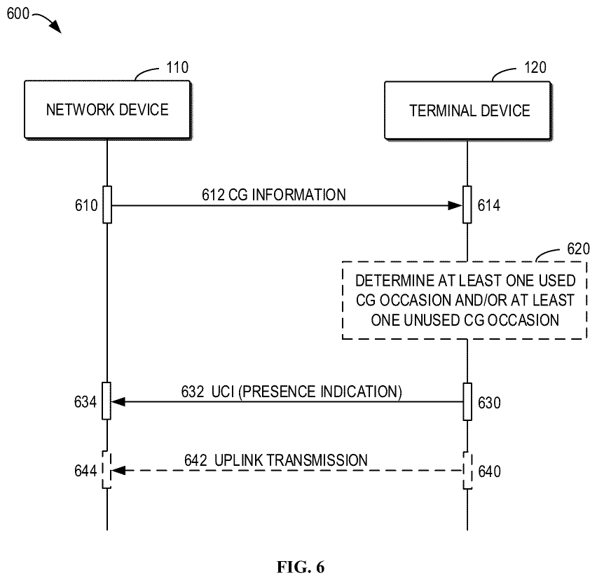

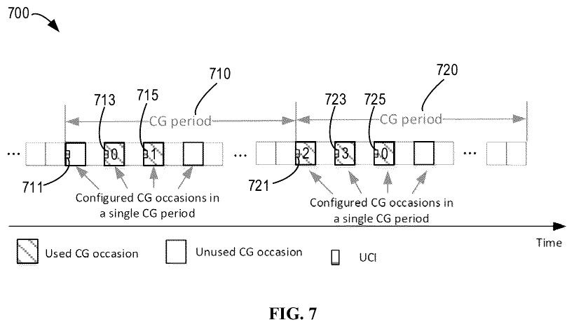

Reference is further made to FIG. 6, which illustrates a signalling chart illustrating communication process 600 in accordance with some example embodiments of the present disclosure. Only for the purpose of discussion, the process 600 will be described with reference to FIG. 1. The process 600 may involve the network device 110 and the terminal device 120.

The network device 110 transmits 610 CG information 612 to the terminal device 120. In some example embodiments, the CG information 612 may indicate multiple configured CG occasions in a CG period. In some examples, the number of the multiple configured CG occasions may be represented as Ncg, which may be an integer greater than 0. For example, 1≤Ncg≤8. It is to be understood that the value of Ncg may be any integer and the present disclosure does not limit this aspect. In other words, the CG information 612 may indicate that there are Ncg configured CG occasions per CG period.

In some example embodiments, the CG information 612 may indicate a type 1 CG. In some examples, the CG information 612 may include a CG configuration, for example, the CG information 612 may be transmitted via an RRC message/signalling.

In some example embodiments, the CG information 612 may indicate a type 2 CG. In some examples, the CG information 612 may be transmitted via an RRC message/signalling or may be transmitted via downlink control information (DCI). In some example, the DCI may be used to activate the multiple configured CG occasions in a CG period.

Accordingly, the network device 110 may indicate to the terminal device 120 that a CG period comprises Ncg configured CG occasions. On the other side of communication, the terminal device 120 receives 414 the CG information 612. The terminal device 120 may determine Ncg configured CG occasions in a CG period based on the CG information 612.

In the present disclosure, a configured CG occasion may refer to a transmission occasion for a CG PUSCH. For example, a configured CG occasion may occupy multiple time units, where a time unit may be a symbol, a slot, a sub-frame, a frame, etc.

Additionally or alternatively, the terminal device 120 may determine 620 at least one used CG occasion and/or at least one unused CG occasion from the multiple configured CG occasions. The operation of the determination may refer to those discussed with reference to FIG. 2 or FIG. 4, and thus will not be repeated herein.

The terminal device 120 transmits 630 a UCI 632 to the network device 110. In some example embodiments, the UCI 442 may be associated with a configured CG occasion and may include a presence indication to indicate whether an uplink shared channel (UL-SCH) is transmitted in the configured CG occasion.

In some example embodiments, the UCI 442 may be associated with each of: the at least one used CG occasion, the configured CG occasion(s) before the at least one used CG occasion.

In some examples, the traffic burst may arrive later than the start of the first configured CG occasion among the multiple configured CG occasions, thus the terminal device 120 may determine the at least one used CG occasion starting from a middle configured CG occasion. In some example, the terminal device 120 may be not able to transmit UL-SCH in the first N1 configured CG occasions due to the late arrival of traffic burst.

In some examples, the terminal device 120 may transmit the UCI associated with each of the first N1 configured CG occasions, and the presence indication in the UCI may indicate that the associated CG occasion does not include a UL-SCH. For example, the presence indication may have a predefined value (such as 0), which means no UL-SCH is transmitted in the associated CG occasion.

In some example embodiments, the UCI may further include a number indication which is used to indicate one or more of: a first number of at least one used CG occasion, a second number of at least one unused CG occasion, a first index of a last used CG occasion among the at least one used CG occasion, or a second index of a first unused CG occasion among the at least one unused CG occasion. In some example embodiments, the UCI may further include an HPI which is used to indicate a HARQ process number of the associated CG occasion.

In some examples, for the UCI associated with each of the first N1 configured CG occasions, the number indication and/or the HPI may be predefined values, such as all zero values.

In some examples, the presence indication may be implicitly indicated by the number indication and/or the HPI. For example, a field of the presence indication may be omitted from the UCI, and a special value of the number indication and/or the HPI may be used to indicate whether a UL-SCH is transmitted in the configured CG occasion. For example, the number indication and the HPI are all one values or all zero values may mean that there is no UL-SCH in the configured CG occasion.

On the other side of communication, the network device 110 receives 634 the UCI 632. In some examples, the UCI 632 associated with each of the first N1 configured CG occasions includes a presence indication indicating that there is no UL-SCH in the first N1 configured CG occasions, and the network device 110 may ignore the number indication and the HPI in the UCI 632. In some examples, the UCI 632 associated with each of the first N1 configured CG occasions may not explicitly include a presence indication, the network device 110 may determine that the number indication and the HPI in the UCI 632 are predefined values (such as all zero values) and may further determine that the number indication and the HPI implicitly indicate that there is no UL-SCH in the first N1 configured CG occasions.

Additionally or alternatively, the terminal device 120 may transmit 640 an uplink transmission 642 to the network device 110. In some example embodiments, the terminal device 120 may transmit the UL-SCH in the N1+1 configured CG occasion after the arrival of the traffic burst, the terminal device 120 may further transmit a UCI associated with the N1+1 configured CG occasion. It is understood that the N1+1 configured CG occasion may be one of the at least one used CG occasion.

In some example embodiments, the UCI associated with a used CG occasion may include one or more of: a presence indication indicating that there is UL-SCH in the configured CG occasion, a first indication indicating a first index of a last used CG occasion among the at least one used CG occasion, a second indication indicating a second index of a first unused CG occasion after the at least one used CG occasion, or a HARQ process indication indicating a HARQ process number of the configured CG occasion. In some examples, the presence indication may have a further predefined value (such as 1), which means there is a UL-SCH transmitted in the associated CG occasion.

Additionally or alternatively, the terminal device120 may determine a HARQ process number of each of the at least one used CG occasion. The operation of determining the HARQ process number may refer to those discussed above with reference to FIG. 2 or FIG. 4, and thus will not be repeated herein.

On the other side of communication, the network device 110 receives 644 the uplink transmission 642. The network device 110 may further receive the UCI associated with the used CG occasion.

FIG. 7 illustrates a schematic diagram 700 of the association between a UCI and a CG occasion in accordance with some embodiments of the present disclosure. It is assumed that Ncg=4 and nrofHARQ-Processes=4. There are a CG period 710 and a CG period 720 shown in FIG. 7, and there are 4 configured CG occasions in each CG period. A UCI may be a CG-UCI, which may be transmitted in one of the configured CG occasions.

The terminal device 120 may determine at least one used CG occasion. The terminal device 120 may further determine the HARQ process number for each of the at least one used CG occasion. As shown in FIG. 7, it is assumed that the terminal device 120 determines 2 used CG occasions in the CG period 710 with HARQ process numbers 0-1, and 3 used CG occasions in the CG period 720 with HARQ process numbers 2-3 and 0. Since the traffic burst arrives later than the first configured CG occasion, the at least one used CG occasion is not started from the first configured CG occasion.

As an example, a UCI 711 associated with the first configured CG occasion indicates that there is no UL-SCH in the first configured CG occasion. A UCI 713 associated with the second configured CG occasion indicates that there is a UL-SCH in the second configured CG occasion, and further indicates the HARQ process number of the second configured CG occasion is 0. A UCI 715 associated with the third configured CG occasion indicates that there is a UL-SCH in the third configured CG occasion, and further indicates the HARQ process number of the third configured CG occasion is 1.

As an example, UCIs 721, 723, and 715 associated with the first three configured CG occasions in CG period 720 respectively, each may indicate a presence of the UL-SCH and may further indicate the HARQ process numbers of the three configured CG occasions are 2, 3, and 0 respectively.

According to the example embodiments described with reference to FIGS. 6-7, a UCI including a presence indication is transmitted from the terminal device 120 to the network device 110, as such, the network device 110 may be aware of whether the UL-SCH is transmitted, thus the network device 110 may know whether the traffic burst is arrived late at the terminal device 120. Therefore, the efficiency of communication between the terminal device and the network device may be improved.

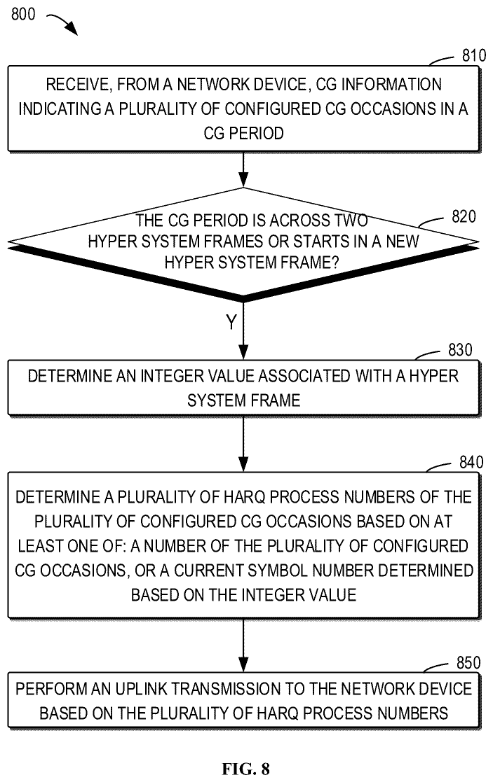

FIG. 8 illustrates a flowchart of an example method 800 implemented at a terminal device in accordance with some embodiments of the present disclosure. For the purpose of discussion, the method 800 will be described from the perspective of the terminal device 120 with reference to FIG. 1.

At block 810, the terminal device 120 receives, from the network device, CG information indicating a plurality of configured CG occasions in a CG period. At block 820, the terminal device 120 determines whether a CG period is across two hyper system frames or starts in a new hyper system frame. At block 830, if the CG period is across two hyper system frames or starts in a new hyper system frame, the terminal device 120 determines an integer value associated with a hyper system frame. At block 840, the terminal device 120 determines a plurality of HARQ process numbers of the plurality of configured CG occasions based on at least one of: a number of the plurality of configured CG occasions, or a current symbol number determined based on the integer value. At block 850, the terminal device 120 performs an uplink transmission to the network device based on the plurality of HARQ process numbers.

In some example embodiments, the terminal device 120 determines the integer value as a predefined value when a system frame number (SFN) equals to a reference SFN or an SFN start time, or updates the integer value by incrementing by 1 at the beginning of the new hyper system frame.

In some example embodiments, the terminal device 120 determines the reference SFN or the SFN start time based on the CG information.

In some example embodiments, the integer value is a hyper system frame number of the hyper system frame the plurality of configured CG occasions in.

In some example embodiments, the terminal device 120 determines at least one used CG occasion and/or at least one unused CG occasion from the plurality of configured CG occasions. In some example embodiments, the terminal device 120 transmits, to the network device 110, a UCI indicating at least one of: a first number of the at least one used CG occasion, a second number of the at least one unused CG occasion, a first index of a last used CG occasion among the at least one used CG occasion, or a second index of a first unused CG occasion among the at least one unused CG occasion.

In some example embodiments, the UCI further indicates the plurality of HARQ process numbers.

In some example embodiments, the terminal device 120 receives, from the network device 110, a DCI indicating the terminal device to retransmit with an indicated HARQ process number of one of the at least one used CG occasions. In some example embodiments, the terminal device 120 performs an uplink retransmission based on the DCI in the one of the at least one used CG occasions.

In some example embodiments, the terminal device 120 determines that a configured CG occasion overlapping with an unavailable resource is one of the at least one unused CG occasion.

In some example embodiments, if the CG period is not across two hyper system frames or starts in a new hyper system frame, the terminal device 120 determines a plurality of HARQ process numbers of the plurality of configured CG occasions based on a number of the plurality of configured CG occasions and a current symbol number, the current symbol number being at least one of: a symbol index of a first symbol in a first configured CG occasion among the plurality of configured CG occasions, or a symbol index of a first symbol in an associated configured CG occasion of the plurality of configured CG occasions.

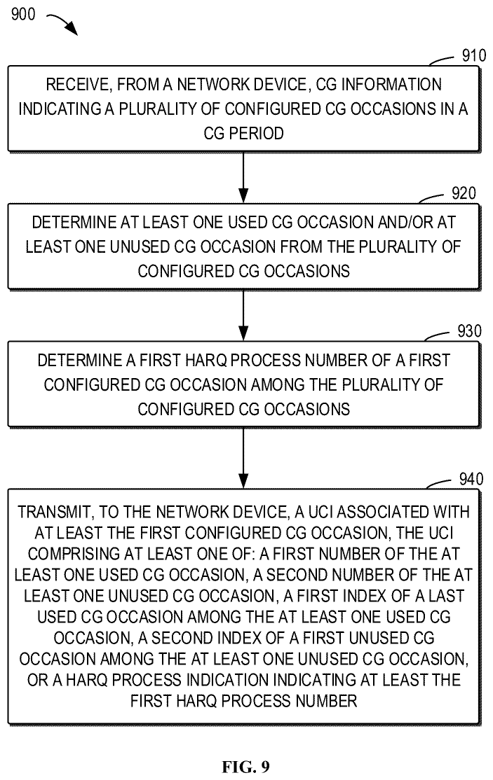

FIG. 9 illustrates a flowchart of an example method 900 implemented at a terminal device in accordance with some embodiments of the present disclosure. For the purpose of discussion, the method 900 will be described from the perspective of the terminal device 120 with reference to FIG. 1.

At block 910, the terminal device 120 receives, from the network device 110, CG information indicating a plurality of configured CG occasions in a CG period. At block 920, the terminal device 120 determines at least one used CG occasion and/or at least one unused CG occasion from the plurality of configured CG occasions. At block 930, the terminal device 120 determines a first HARQ process number of a first configured CG occasion among the plurality of configured CG occasions. At block 940, the terminal device 120 transmits, to the network device 110, a UCI associated with at least the first configured CG occasion, the UCI comprising at least one of: a first number of the at least one used CG occasion, a second number of the at least one unused CG occasion, a first index of a last used CG occasion among the at least one used CG occasion, a second index of a first unused CG occasion among the at least one unused CG occasion, or a HARQ process indication indicating at least the first HARQ process number.

In some example embodiments, the terminal device 120 determines the first HARQ process number of the first configured CG occasion based on at least one of: a number of the plurality of configured CG occasions, or a symbol index of a first symbol in the first configured CG occasion.

In some example embodiments, if an uplink transmission in the first configured CG occasion is a retransmission or a repetition, the terminal device 120 determines that the first HARQ process number of the first configured CG occasion being equal to a second HARQ process number of a second configured CG occasion for a first transmission.

In some example embodiments, the terminal device 120 determines a second HARQ process number of a second used CG occasion among the at least one used CG occasion based on a HARQ process number of a first used CG occasion being closest to the second used CG occasion and before the second used CG occasion plus 1.

In some example embodiments, the UCI comprises at least one UCI associated with the at least one used CG occasion.

In some example embodiments, the HARQ process indication in each of the at least one UCI is used to indicate a HARQ process number of an associated used CG occasion.

In some example embodiments, the terminal device 120 determines at least one HARQ process number of the at least one used CG occasion based on at least one of: a number of the plurality of configured CG occasions, or a symbol index of a first symbol in a first configured CG occasion among the plurality of configured CG occasions, or a symbol index of a first symbol in the associated used CG occasion.

In some example embodiments, at least one HARQ process number of the at least one used CG occasion is continuous.

In some example embodiments, the terminal device 120 determines that a configured CG occasion overlapping with an unavailable resource is one of the at least one unused CG occasion.

In some example embodiments, the first number is greater than or equal to a preconfigured or predefined minimum number.

In some example embodiments, the second number is less than or equal to a number being a difference of a number of the plurality of CG occasions and a preconfigured or predefined minimum number.

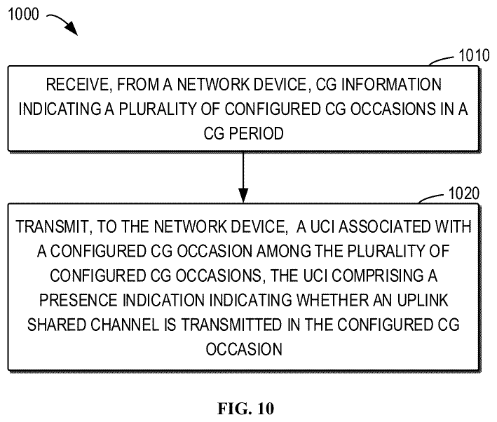

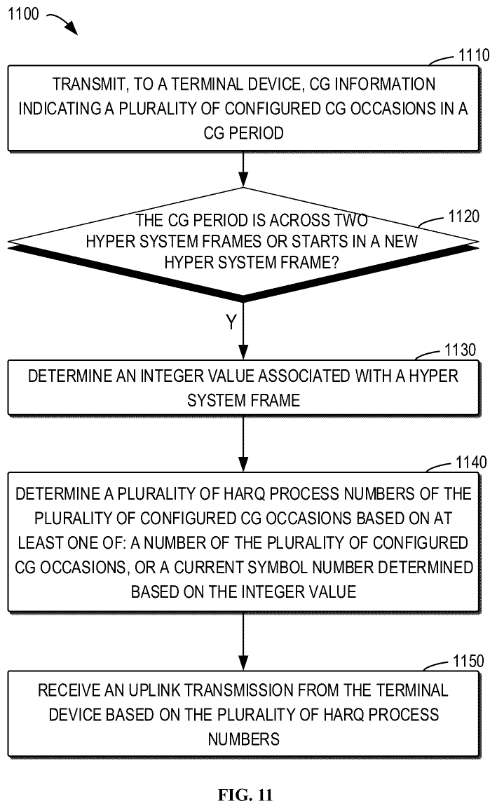

FIG. 10 illustrates a flowchart of an example method 1000 implemented at a terminal device in accordance with some embodiments of the present disclosure. For the purpose of discussion, the method 1000 will be described from the perspective of the terminal device 120 with reference to FIG. 1.

At block 1010, the terminal device 120 receives, from the network device, CG information indicating a plurality of configured CG occasions in a CG period. At block 1020, the terminal device 120 transmits, to the network device, a UCI associated with a configured CG occasion among the plurality of configured CG occasions, the UCI comprising a presence indication indicating whether an uplink shared channel is transmitted in the configured CG occasion.

In some example embodiments, the terminal device 120 determines at least one used CG occasion and/or at least one unused CG occasion from the plurality of configured CG occasions.

In some example embodiments, the configured CG occasion comprises one of at least one configured CG occasion before the at least one used CG occasion in the CG period.

In some example embodiments, the UCI further comprises at least one of: a number indication or a HARQ process indication (HPI) with predefined values.

In some example embodiments, the presence indication is implicitly indicated by at least one of: the number indication, or the HARQ process indication.

In some example embodiments, the configured CG occasion comprises one of the at least one used CG occasion.

In some example embodiments, the UCI further comprises at least one of: a first indication indicating a first index of a last used CG occasion among the at least one used CG occasion, a second indication indicating a second index of a first unused CG occasion after the at least one used CG occasion, or a HARQ process indication indicating a HARQ process number of the configured CG occasion.

In some example embodiments, the terminal device 120 determines that a configured CG occasion overlapping with an unavailable resource is one of the at least one unused CG occasion.

In some example embodiments, the terminal device 120 transmits an uplink shared channel to the network device after an arrival of a traffic burst.

FIG. 11 illustrates a flowchart of an example method 1100 implemented at a network device in accordance with some embodiments of the present disclosure. For the purpose of discussion, the method 1100 will be described from the perspective of the network device 110 with reference to FIG. 1.

At block 1110, the network device 110 transmits, to a terminal device, CG information indicating a plurality of configured CG occasions in a CG period. At block 1120, the network device 110 determines whether the CG period is across two hyper system frames or starts in a new hyper system frame. At block 1130, if the CG period is across two hyper system frames or starts in a new hyper system frame, the network device 110 determines an integer value associated with a hyper system frame. At block 1140, the network device 110 determines a plurality of HARQ process numbers of the plurality of configured CG occasions based on at least one of: a number of the plurality of configured CG occasions, or a current symbol number determined based on the integer value. At block 1150, the network device 110 receives an uplink transmission from the terminal device based on the plurality of HARQ process numbers.

In some example embodiments, the network device 110 determines the integer value as a predefined value when a system frame number (SFN) equals to a reference SFN or an SFN start time, or updates the integer value by incrementing by 1 at the beginning of the new hyper system frame.

In some example embodiments, the CG information further indicates the reference SFN or the SFN start time.

In some example embodiments, the integer value is a hyper system frame number of the hyper system frame the plurality of configured CG occasions in.

In some example embodiments, the network device 110 receives, from the terminal device, a UCI indicating at least one of: a first number of at least one used CG occasion among the plurality of configured CG occasions, a second number of at least one unused CG occasion among the plurality of configured CG occasions, a first index of a last used CG occasion among the at least one used CG occasion, or a second index of a first unused CG occasion among the at least one unused CG occasion.

In some example embodiments, the UCI further indicates the plurality of HARQ process numbers.

In some example embodiments, the network device 110 transmits, to the terminal device, downlink control information (DCI) indicating the terminal device to retransmit with an indicated HARQ process number of one of the at least one used CG occasions. In some example embodiments, the network device 110 receives, from the terminal device, an uplink retransmission based on the DCI in the one of the at least one used CG occasions.

In some example embodiments, if the CG period is not across two hyper system frames or starts in a new hyper system frame, the network device 110 determines a plurality of HARQ process numbers of the plurality of configured CG occasions based on a number of the plurality of configured CG occasions and a current symbol number, the current symbol number being at least one of: a symbol index of a first symbol in a first configured CG occasion among the plurality of configured CG occasions, or a symbol index of a first symbol in an associated configured CG occasion of the plurality of configured CG occasions.

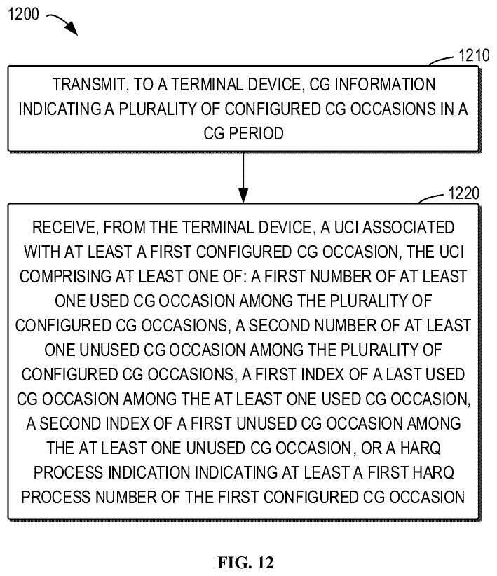

FIG. 12 illustrates a flowchart of an example method 1200 implemented at a network device in accordance with some embodiments of the present disclosure. For the purpose of discussion, the method 1200 will be described from the perspective of the network device 110 with reference to FIG. 1.

At block 1210, the network device 110 transmits, to a terminal device, CG information indicating a plurality of configured CG occasions in a CG period. At block 1220, the network device 110 receives, from the terminal device, a UCI associated with at least a first configured CG occasion, the UCI comprising at least one of: a first number of at least one used CG occasion among the plurality of configured CG occasions, a second number of at least one unused CG occasion among the plurality of configured CG occasions, a first index of a last used CG occasion among the at least one used CG occasion, a second index of a first unused CG occasion among the at least one unused CG occasion, or a HARQ process indication indicating at least a first HARQ process number of the first configured CG occasion.

In some example embodiments, the network device 110 determines the first HARQ process number of the first configured CG occasion based on at least one of: a number of the plurality of configured CG occasions, or a symbol index of a first symbol in the first configured CG occasion.

In some example embodiments, if an uplink transmission in the first configured CG occasion is a retransmission or a repetition, the network device 110 determines that the first HARQ process number of the first configured CG occasion being equal to a second HARQ process number of a second configured CG occasion for a first transmission.

In some example embodiments, the network device 110 determines a second HARQ process number of a second used CG occasion among the at least one used CG occasion based on a HARQ process number of a first used CG occasion being closest to the second used CG occasion and before the second used CG occasion plus 1.

In some example embodiments, the UCI comprises at least one UCI associated with the at least one used CG occasion.

In some example embodiments, the HARQ process indication in each of the at least one UCI is used to indicate a HARQ process number of an associated CG occasion.

In some example embodiments, the network device 110 determines at least one HARQ process number of the at least one used CG occasion based on at least one of: a number of the plurality of configured CG occasions, or a symbol index of a first symbol in a first configured CG occasion among the plurality of configured CG occasions, or a symbol index of a first symbol in the associated used CG occasion.

In some example embodiments, at least one HARQ process number of the at least one used CG occasion is continuous.

In some example embodiments, the at least one UCI comprises a first UCI and a second UCI with information, and the network device 110 determines the at least one used CG occasion based on a most recent received UCI.

In some example embodiments, the first number is greater than or equal to a preconfigured or predefined minimum number.

In some example embodiments, the second number is less than or equal to a number being a difference of a number of the plurality of CG occasions and a preconfigured or predefined minimum number.

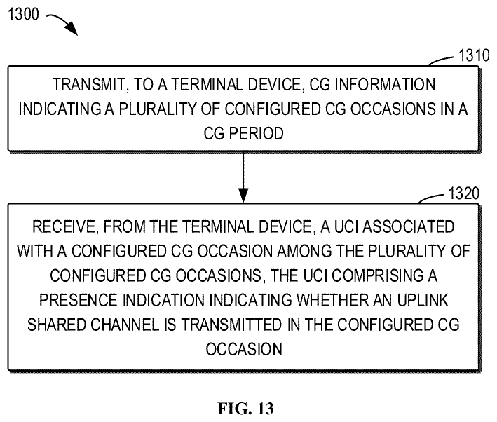

FIG. 13 illustrates a flowchart of an example method 1300 implemented at a network device in accordance with some embodiments of the present disclosure. For the purpose of discussion, the method 1300 will be described from the perspective of the network device 110 with reference to FIG. 1.

At block 1310, the network device 110 transmits, to a terminal device, CG information indicating a plurality of configured CG occasions in a CG period. At block 1320, the network device 110 receives, from the terminal device, a UCI associated with a configured CG occasion among the plurality of configured CG occasions, the UCI comprising a presence indication indicating whether an uplink shared channel is transmitted in the configured CG occasion.

In some example embodiments, the configured CG occasion comprises one of at least one configured CG occasion before at least one used CG occasion in the CG period.

In some example embodiments, the UCI further comprises at least one of: a number indication or a HARQ process indication with predefined values.

In some example embodiments, the presence indication is implicitly indicated by at least one of: the number indication, or the HARQ process indication.

In some example embodiments, if the presence indication indicates that no uplink shared channel is transmitted in the associated CG occasion, the network device 110 ignores the number indication and the HARQ process indication in the UCI.

In some example embodiments, the configured CG occasion comprises one of at least one used CG occasion.

In some example embodiments, the UCI further comprises at least one of: a first indication indicating a first index of a last used CG occasion among the at least one used CG occasion, a second indication indicating a second index of a first unused CG occasion after at least one used CG occasion, or a HARQ process indication indicating a HARQ process number of the configured CG occasion.

Details of some embodiments according to the present disclosure have been described with reference to FIGS. 1-13. Now an example implementation of the terminal device and the network device will be discussed below.

In some example embodiments, a terminal device comprises circuitry configured to: receive, from a network device, CG information indicating a plurality of configured CG occasions in a CG period; determine whether the CG period is across two hyper system frames or starts in a new hyper system frame; in accordance with a determination that the CG period is across two hyper system frames or starts in a new hyper system frame, determine an integer value associated with a hyper system frame; determine a plurality of HARQ process numbers of the plurality of configured CG occasions based on at least one of: a number of the plurality of configured CG occasions, or a current symbol number determined based on the integer value; and perform an uplink transmission to the network device based on the plurality of HARQ process numbers.

In some example embodiments, the terminal device comprises circuitry configured to: determine the integer value as a predefined value when a system frame number (SFN) equals to a reference SFN or an SFN start time, or update the integer value by incrementing by 1 at the beginning of the new hyper system frame.

In some example embodiments, the terminal device comprises circuitry configured to: determine the reference SFN or the SFN start time based on the CG information.

In some example embodiments, the integer value is a hyper system frame number of the hyper system frame the plurality of configured CG occasions in.

In some example embodiments, the terminal device comprises circuitry configured to: determine at least one used CG occasion and/or at least one unused CG occasion from the plurality of configured CG occasions; and transmit, to the network device, uplink control information (UCI) indicating at least one of: a first number of the at least one used CG occasion, a second number of the at least one unused CG occasion, a first index of a last used CG occasion among the at least one used CG occasion, or a second index of a first unused CG occasion among the at least one unused CG occasion.

In some example embodiments, the UCI further indicates the plurality of HARQ process numbers.

In some example embodiments, the terminal device comprises circuitry configured to: receive, from the network device, downlink control information (DCI) indicating the terminal device to retransmit with an indicated HARQ process number of one of the at least one used CG occasions; and perform an uplink retransmission based on the DCI in the one of the at least one used CG occasions.

In some example embodiments, the terminal device comprises circuitry configured to: determine that a configured CG occasion overlapping with an unavailable resource is one of the at least one unused CG occasion.

In some example embodiments, the terminal device comprises circuitry configured to: in accordance with a determination that the CG period is not across two hyper system frames or starts in a new hyper system frame, determine a plurality of HARQ process numbers of the plurality of configured CG occasions based on a number of the plurality of configured CG occasions and a current symbol number, the current symbol number being at least one of: a symbol index of a first symbol in a first configured CG occasion among the plurality of configured CG occasions, or a symbol index of a first symbol in an associated configured CG occasion of the plurality of configured CG occasions.

In some example embodiments, a terminal device comprises circuitry configured to: receive, from a network device, CG information indicating a plurality of configured CG occasions in a CG period; determine at least one used CG occasion and/or at least one unused CG occasion from the plurality of configured CG occasions; determine a first HARQ process number of a first configured CG occasion among the plurality of configured CG occasions; and transmit, to the network device, uplink control information (UCI) associated with at least the first configured CG occasion, the UCI comprising at least one of: a first number of the at least one used CG occasion, a second number of the at least one unused CG occasion, a first index of a last used CG occasion among the at least one used CG occasion, a second index of a first unused CG occasion among the at least one unused CG occasion, or a HARQ process indication indicating at least the first HARQ process number.

In some example embodiments, the terminal device comprises circuitry configured to determine the first HARQ process number by: determining the first HARQ process number of the first configured CG occasion based on at least one of: a number of the plurality of configured CG occasions, or a symbol index of a first symbol in the first configured CG occasion.

In some example embodiments, the terminal device comprises circuitry configured to determine the first HARQ process number by: in accordance with a determination that an uplink transmission in the first configured CG occasion is a retransmission or a repetition, determining that the first HARQ process number of the first configured CG occasion being equal to a second HARQ process number of a second configured CG occasion for a first transmission.

In some example embodiments, the terminal device comprises circuitry configured to: determine a second HARQ process number of a second used CG occasion among the at least one used CG occasion based on a HARQ process number of a first used CG occasion being closest to the second used CG occasion and before the second used CG occasion plus 1.

In some example embodiments, the UCI comprises at least one UCI associated with the at least one used CG occasion.

In some example embodiments, the HARQ process indication in each of the at least one UCI is used to indicate a HARQ process number of an associated used CG occasion.

In some example embodiments, the terminal device comprises circuitry configured to: determine at least one HARQ process number of the at least one used CG occasion based on at least one of: a number of the plurality of configured CG occasions, or a symbol index of a first symbol in a first configured CG occasion among the plurality of configured CG occasions, or a symbol index of a first symbol in the associated used CG occasion.

In some example embodiments, at least one HARQ process number of the at least one used CG occasion is continuous.

In some example embodiments, the terminal device comprises circuitry configured to determine the at least one unused CG occasion by: determining that a configured CG occasion overlapping with an unavailable resource is one of the at least one unused CG occasion.

In some example embodiments, the first number is greater than or equal to a preconfigured or predefined minimum number.

In some example embodiments, the second number is less than or equal to a number being a difference of a number of the plurality of CG occasions and a preconfigured or predefined minimum number.

In some example embodiments, a terminal device comprises circuitry configured to: receive, from a network device, CG information indicating a plurality of configured CG occasions in a CG period; and transmit, to the network device, uplink control information (UCI) associated with a configured CG occasion among the plurality of configured CG occasions, the UCI comprising a presence indication indicating whether an uplink shared channel is transmitted in the configured CG occasion.

In some example embodiments, the terminal device comprises circuitry configured to: determine at least one used CG occasion and/or at least one unused CG occasion from the plurality of configured CG occasions.

In some example embodiments, the configured CG occasion comprises one of at least one configured CG occasion before the at least one used CG occasion in the CG period.

In some example embodiments, the UCI further comprises at least one of: a number indication or a HARQ process indication with predefined values.

In some example embodiments, the presence indication is implicitly indicated by at least one of: the number indication, or the HARQ process indication.

In some example embodiments, the configured CG occasion comprises one of the at least one used CG occasion.

In some example embodiments, the UCI further comprises at least one of: a first indication indicating a first index of a last used CG occasion among the at least one used CG occasion, a second indication indicating a second index of a first unused CG occasion after the at least one used CG occasion, or a HARQ process indication indicating a HARQ process number of the configured CG occasion.

In some example embodiments, the terminal device comprises circuitry configured to determine the at least one unused CG occasion by: determining that a configured CG occasion overlapping with an unavailable resource is one of the at least one unused CG occasion.

In some example embodiments, the terminal device comprises circuitry configured to: transmit an uplink shared channel to the network device after an arrival of a traffic burst.

In some example embodiments, a network device comprises circuitry configured to: transmit, to a terminal device, CG information indicating a plurality of configured CG occasions in a CG period; determine whether the CG period is across two hyper system frames or starts in a new hyper system frame; in accordance with a determination that the CG period is across two hyper system frames or starts in a new hyper system frame, determine an integer value associated with a hyper system frame; determine a plurality of HARQ process numbers of the plurality of configured CG occasions based on at least one of: a number of the plurality of configured CG occasions, or a current symbol number determined based on the integer value; and receive an uplink transmission from the terminal device based on the plurality of HARQ process numbers.

In some example embodiments, the network device comprises circuitry configured to determine the integer value by: determining the integer value as a predefined value when a system frame number (SFN) equals to a reference SFN or an SFN start time, or updating the integer value by incrementing by 1 at the beginning of the new hyper system frame.

In some example embodiments, the CG information further indicates the reference SFN or the SFN start time.

In some example embodiments, the integer value is a hyper system frame number of the hyper system frame the plurality of configured CG occasions in.

In some example embodiments, the network device comprises circuitry configured to: receive, from the terminal device, uplink control information (UCI) indicating at least one of: a first number of at least one used CG occasion among the plurality of configured CG occasions, a second number of at least one unused CG occasion among the plurality of configured CG occasions, a first index of a last used CG occasion among the at least one used CG occasion, or a second index of a first unused CG occasion among the at least one unused CG occasion.

In some example embodiments, the UCI further indicates the plurality of HARQ process numbers.

In some example embodiments, the network device comprises circuitry configured to: transmit, to the terminal device, downlink control information (DCI) indicating the terminal device to retransmit with an indicated HARQ process number of one of the at least one used CG occasions; and receive, from the terminal device, an uplink retransmission based on the DCI in the one of the at least one used CG occasions.

In some example embodiments, the network device comprises circuitry configured to: in accordance with a determination that the CG period is not across two hyper system frames or starts in a new hyper system frame, determine a plurality of HARQ process numbers of the plurality of configured CG occasions based on a number of the plurality of configured CG occasions and a current symbol number, the current symbol number being at least one of: a symbol index of a first symbol in a first configured CG occasion among the plurality of configured CG occasions, or a symbol index of a first symbol in an associated configured CG occasion of the plurality of configured CG occasions.

In some example embodiments, a network device comprises circuitry configured to: transmit, to a terminal device, CG information indicating a plurality of configured CG occasions in a CG period; and receive, from the terminal device, uplink control information (UCI) associated with at least a first configured CG occasion, the UCI comprising at least one of: a first number of at least one used CG occasion among the plurality of configured CG occasions, a second number of at least one unused CG occasion among the plurality of configured CG occasions, a first index of a last used CG occasion among the at least one used CG occasion, a second index of a first unused CG occasion among the at least one unused CG occasion, or a HARQ process indication indicating at least a first HARQ process number of the first configured CG occasion.

In some example embodiments, the network device comprises circuitry configured to: determine the first HARQ process number of the first configured CG occasion based on at least one of: a number of the plurality of configured CG occasions, or a symbol index of a first symbol in the first configured CG occasion.

In some example embodiments, the network device comprises circuitry configured to determine the first HARQ process number by: in accordance with a determination that an uplink transmission in the first configured CG occasion is a retransmission or a repetition, determining that the first HARQ process number of the first configured CG occasion being equal to a second HARQ process number of a second configured CG occasion for a first transmission.

In some example embodiments, the network device comprises circuitry configured to: determine a second HARQ process number of a second used CG occasion among the at least one used CG occasion based on a HARQ process number of a first used CG occasion being closest to the second used CG occasion and before the second used CG occasion plus 1.

In some example embodiments, the UCI comprises at least one UCI associated with the at least one used CG occasion.

In some example embodiments, the HARQ process indication in each of the at least one UCI is used to indicate a HARQ process number of an associated CG occasion.

In some example embodiments, the network device comprises circuitry configured to: determine at least one HARQ process number of the at least one used CG occasion based on at least one of: a number of the plurality of configured CG occasions, or a symbol index of a first symbol in a first configured CG occasion among the plurality of configured CG occasions, or a symbol index of a first symbol in the associated used CG occasion.

In some example embodiments, at least one HARQ process number of the at least one used CG occasion is continuous.

In some example embodiments, the at least one UCI comprises a first UCI and a second UCI with information, the network device comprises circuitry configured to: determine the at least one used CG occasion based on a most recent received UCI.

In some example embodiments, the first number is greater than or equal to a preconfigured or predefined minimum number.

In some example embodiments, the second number is less than or equal to a number being a difference of a number of the plurality of CG occasions and a preconfigured or predefined minimum number.

In some example embodiments, a network device comprises circuitry configured to: transmit, to a terminal device, CG information indicating a plurality of configured CG occasions in a CG period; and receive, from the terminal device, uplink control information (UCI) associated with a configured CG occasion among the plurality of configured CG occasions, the UCI comprising a presence indication indicating whether an uplink shared channel is transmitted in the configured CG occasion.

In some example embodiments, the configured CG occasion comprises one of at least one configured CG occasion before at least one used CG occasion in the CG period.

In some example embodiments, the UCI further comprises at least one of: a number indication or a HARQ process indication with predefined values.

In some example embodiments, the presence indication is implicitly indicated by at least one of: the number indication, or the HARQ process indication.

In some example embodiments, the network device comprises circuitry configured to: in accordance with a determination that the presence indication indicates that no uplink shared channel is transmitted in the associated CG occasion, ignore the number indication and the HARQ process indication in the UCI.

In some example embodiments, the configured CG occasion comprises one of at least one used CG occasion.

In some example embodiments, the UCI further comprises at least one of: a first indication indicating a first index of a last used CG occasion among the at least one used CG occasion, a second indication indicating a second index of a first unused CG occasion after at least one used CG occasion, or a HARQ process indication indicating a HARQ process number of the configured CG occasion.

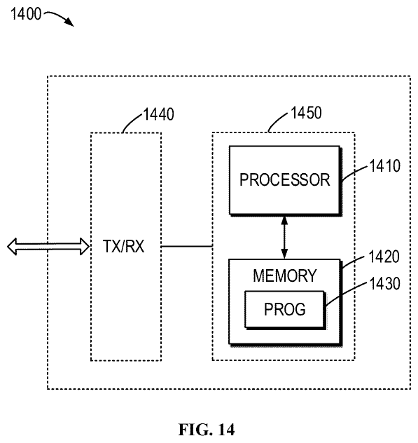

FIG. 14 illustrates a simplified block diagram of a device 1400 that is suitable for implementing embodiments of the present disclosure. The device 1400 can be considered as a further example implementation of the terminal device 120, and the network device 110 as shown in FIG. 1. Accordingly, the device 1400 can be implemented at or as at least a part of the terminal device 120, or the network device 110.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1430 is assumed to include program instructions that, when executed by the associated processor 1410, enable the device 1400 to operate in accordance with the embodiments of the present disclosure, as discussed herein with reference to FIGS. 1-13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In summary, embodiments of the present disclosure may provide the following solutions.

The present disclosure provides a terminal device, comprising at least one processor configured to cause the terminal device at least to: receive, from a network device, CG information indicating a plurality of configured CG occasions in a CG period; determine whether the CG period is across two hyper system frames or starts in a new hyper system frame; in accordance with a determination that the CG period is across two hyper system frames or starts in a new hyper system frame, determine an integer value associated with a hyper system frame; determine a plurality of HARQ process numbers of the plurality of configured CG occasions based on at least one of: a number of the plurality of configured CG occasions, or a current symbol number determined based on the integer value; and perform an uplink transmission to the network device based on the plurality of HARQ process numbers.

In one embodiment, the terminal device as above, the terminal device is caused to determine the integer value by: determining the integer value as a predefined value when a system frame number (SFN) equals to a reference SFN or an SFN start time, or updating the integer value by incrementing by 1 at the beginning of the new hyper system frame.

In one embodiment, the terminal device as above, the terminal device is further caused to: determine the reference SFN or the SFN start time based on the CG information.

In one embodiment, the terminal device as above, the integer value is a hyper system frame number of the hyper system frame the plurality of configured CG occasions in.

In one embodiment, the terminal device as above, the terminal device is further caused to: determine at least one used CG occasion and/or at least one unused CG occasion from the plurality of configured CG occasions; and transmit, to the network device, uplink control information (UCI) indicating at least one of: a first number of the at least one used CG occasion, a second number of the at least one unused CG occasion, a first index of a last used CG occasion among the at least one used CG occasion, or a second index of a first unused CG occasion among the at least one unused CG occasion.

In one embodiment, the terminal device as above, the UCI further indicates the plurality of HARQ process numbers.

In one embodiment, the terminal device as above, the terminal device is further caused to: receive, from the network device, downlink control information (DCI) indicating the terminal device to retransmit with an indicated HARQ process number of one of the at least one used CG occasions; and perform an uplink retransmission based on the DCI in the one of the at least one used CG occasions.

In one embodiment, the terminal device as above, the terminal device is caused to determine the at least one unused CG occasion by: determining that a configured CG occasion overlapping with an unavailable resource is one of the at least one unused CG occasion.

In one embodiment, the terminal device as above, the terminal device is further caused to: in accordance with a determination that the CG period is not across two hyper system frames or starts in a new hyper system frame, determine a plurality of HARQ process numbers of the plurality of configured CG occasions based on a number of the plurality of configured CG occasions and a current symbol number, the current symbol number being at least one of: a symbol index of a first symbol in a first configured CG occasion among the plurality of configured CG occasions, or a symbol index of a first symbol in an associated configured CG occasion of the plurality of configured CG occasions.

The present disclosure provides a terminal device, comprising at least one processor configured to cause the terminal device at least to: receive, from a network device, CG information indicating a plurality of configured CG occasions in a CG period; determine at least one used CG occasion and/or at least one unused CG occasion from the plurality of configured CG occasions; determine a first HARQ process number of a first configured CG occasion among the plurality of configured CG occasions; and transmit, to the network device, uplink control information (UCI) associated with at least the first configured CG occasion, the UCI comprising at least one of: a first number of the at least one used CG occasion, a second number of the at least one unused CG occasion, a first index of a last used CG occasion among the at least one used CG occasion, a second index of a first unused CG occasion among the at least one unused CG occasion, or a HARQ process indication indicating at least the first HARQ process number.

In one embodiment, the terminal device as above, the terminal device is caused to determine the first HARQ process number by: determining the first HARQ process number of the first configured CG occasion based on at least one of: a number of the plurality of configured CG occasions, or a symbol index of a first symbol in the first configured CG occasion.

In one embodiment, the terminal device as above, the terminal device is caused to determine the first HARQ process number by: in accordance with a determination that an uplink transmission in the first configured CG occasion is a retransmission or a repetition, determining that the first HARQ process number of the first configured CG occasion being equal to a second HARQ process number of a second configured CG occasion for a first transmission.

In one embodiment, the terminal device as above, the terminal device is further caused to: determine a second HARQ process number of a second used CG occasion among the at least one used CG occasion based on a HARQ process number of a first used CG occasion being closest to the second used CG occasion and before the second used CG occasion plus 1.

In one embodiment, the terminal device as above, the UCI comprises at least one UCI associated with the at least one used CG occasion.

In one embodiment, the terminal device as above, the HARQ process indication in each of the at least one UCI is used to indicate a HARQ process number of an associated used CG occasion.

In one embodiment, the terminal device as above, the terminal device is further caused to: determine at least one HARQ process number of the at least one used CG occasion based on at least one of: a number of the plurality of configured CG occasions, or a symbol index of a first symbol in a first configured CG occasion among the plurality of configured CG occasions, or a symbol index of a first symbol in the associated used CG occasion.

In one embodiment, the terminal device as above, at least one HARQ process number of the at least one used CG occasion is continuous.

In one embodiment, the terminal device as above, the terminal device is caused to determine the at least one unused CG occasion by: determining that a configured CG occasion overlapping with an unavailable resource is one of the at least one unused CG occasion.

In one embodiment, the terminal device as above, the first number is greater than or equal to a preconfigured or predefined minimum number.

In one embodiment, the terminal device as above, the second number is less than or equal to a number being a difference of a number of the plurality of CG occasions and a preconfigured or predefined minimum number.

The present disclosure provides a terminal device, comprising at least one processor configured to cause the terminal device at least to: receive, from a network device, CG information indicating a plurality of configured CG occasions in a CG period; and transmit, to the network device, uplink control information (UCI) associated with a configured CG occasion among the plurality of configured CG occasions, the UCI comprising a presence indication indicating whether an uplink shared channel is transmitted in the configured CG occasion.

In one embodiment, the terminal device as above, the terminal device is further caused to: determine at least one used CG occasion and/or at least one unused CG occasion from the plurality of configured CG occasions.

In one embodiment, the terminal device as above, the configured CG occasion comprises one of at least one configured CG occasion before the at least one used CG occasion in the CG period.

In one embodiment, the terminal device as above, the UCI further comprises at least one of: a number indication or a HARQ process indication with predefined values.

In one embodiment, the terminal device as above, the presence indication is implicitly indicated by at least one of: the number indication, or the HARQ process indication.

In one embodiment, the terminal device as above, the configured CG occasion comprises one of the at least one used CG occasion.

In one embodiment, the terminal device as above, the UCI further comprises at least one of: a first indication indicating a first index of a last used CG occasion among the at least one used CG occasion, a second indication indicating a second index of a first unused CG occasion after the at least one used CG occasion, or a HARQ process indication indicating a HARQ process number of the configured CG occasion.

In one embodiment, the terminal device as above, the terminal device is caused to determine the at least one unused CG occasion by: determining that a configured CG occasion overlapping with an unavailable resource is one of the at least one unused CG occasion.

In one embodiment, the terminal device as above, the terminal device is further caused to: transmit an uplink shared channel to the network device after an arrival of a traffic burst.

The present disclosure provides a network device, comprising at least one processor configured to cause the network device at least to: transmit, to a terminal device, CG information indicating a plurality of configured CG occasions in a CG period; determine whether the CG period is across two hyper system frames or starts in a new hyper system frame; in accordance with a determination that the CG period is across two hyper system frames or starts in a new hyper system frame, determine an integer value associated with a hyper system frame; determine a plurality of HARQ process numbers of the plurality of configured CG occasions based on at least one of: a number of the plurality of configured CG occasions, or a current symbol number determined based on the integer value; and receive an uplink transmission from the terminal device based on the plurality of HARQ process numbers.

In one embodiment, the network device as above, the network device is caused to determine the integer value by: determining the integer value as a predefined value when a system frame number (SFN) equals to a reference SFN or an SFN start time, or updating the integer value by incrementing by 1 at the beginning of the new hyper system frame.

In one embodiment, the network device as above, the CG information further indicates the reference SFN or the SFN start time.

In one embodiment, the network device as above, the integer value is a hyper system frame number of the hyper system frame the plurality of configured CG occasions in.

In one embodiment, the network device as above, the network device is further caused to: receive, from the terminal device, uplink control information (UCI) indicating at least one of: a first number of at least one used CG occasion among the plurality of configured CG occasions, a second number of at least one unused CG occasion among the plurality of configured CG occasions, a first index of a last used CG occasion among the at least one used CG occasion, or a second index of a first unused CG occasion among the at least one unused CG occasion.

In one embodiment, the network device as above, the UCI further indicates the plurality of HARQ process numbers.

In one embodiment, the network device as above, the network device is further caused to: transmit, to the terminal device, downlink control information (DCI) indicating the terminal device to retransmit with an indicated HARQ process number of one of the at least one used CG occasions; and receive, from the terminal device, an uplink retransmission based on the DCI in the one of the at least one used CG occasions.

In one embodiment, the network device as above, the network device is further caused to: in accordance with a determination that the CG period is not across two hyper system frames or starts in a new hyper system frame, determine a plurality of HARQ process numbers of the plurality of configured CG occasions based on a number of the plurality of configured CG occasions and a current symbol number, the current symbol number being at least one of: a symbol index of a first symbol in a first configured CG occasion among the plurality of configured CG occasions, or a symbol index of a first symbol in an associated configured CG occasion of the plurality of configured CG occasions.

The present disclosure provides a network device, comprising at least one processor configured to cause the network device at least to: transmit, to a terminal device, CG information indicating a plurality of configured CG occasions in a CG period; and receive, from the terminal device, uplink control information (UCI) associated with at least a first configured CG occasion, the UCI comprising at least one of: a first number of at least one used CG occasion among the plurality of configured CG occasions, a second number of at least one unused CG occasion among the plurality of configured CG occasions, a first index of a last used CG occasion among the at least one used CG occasion, a second index of a first unused CG occasion among the at least one unused CG occasion, or a HARQ process indication indicating at least a first HARQ process number of the first configured CG occasion.

In one embodiment, the network device as above, the network device is further caused to: determine the first HARQ process number of the first configured CG occasion based on at least one of: a number of the plurality of configured CG occasions, or a symbol index of a first symbol in the first configured CG occasion.

In one embodiment, the network device as above, the network device is caused to determine the first HARQ process number by: in accordance with a determination that an uplink transmission in the first configured CG occasion is a retransmission or a repetition, determining that the first HARQ process number of the first configured CG occasion being equal to a second HARQ process number of a second configured CG occasion for a first transmission.

In one embodiment, the network device as above, the network device is further caused to: determine a second HARQ process number of a second used CG occasion among the at least one used CG occasion based on a HARQ process number of a first used CG occasion being closest to the second used CG occasion and before the second used CG occasion plus 1.

In one embodiment, the network device as above, the UCI comprises at least one UCI associated with the at least one used CG occasion.

In one embodiment, the network device as above, the HARQ process indication in each of the at least one UCI is used to indicate a HARQ process number of an associated CG occasion.

In one embodiment, the network device as above, the network device is further caused to: determine at least one HARQ process number of the at least one used CG occasion based on at least one of: a number of the plurality of configured CG occasions, or a symbol index of a first symbol in a first configured CG occasion among the plurality of configured CG occasions, or a symbol index of a first symbol in the associated used CG occasion.

In one embodiment, the network device as above, at least one HARQ process number of the at least one used CG occasion is continuous.

In one embodiment, the network device as above, the at least one UCI comprises a first UCI and a second UCI with information, and the network device is further caused to: determine the at least one used CG occasion based on a most recent received UCI.

In one embodiment, the network device as above, the first number is greater than or equal to a preconfigured or predefined minimum number.

In one embodiment, the network device as above, the second number is less than or equal to a number being a difference of a number of the plurality of CG occasions and a preconfigured or predefined minimum number.

The present disclosure provides a network device, comprising at least one processor configured to cause the network device at least to: transmit, to a terminal device, CG information indicating a plurality of configured CG occasions in a CG period; and receive, from the terminal device, uplink control information (UCI) associated with a configured CG occasion among the plurality of configured CG occasions, the UCI comprising a presence indication indicating whether an uplink shared channel is transmitted in the configured CG occasion.

In one embodiment, the network device as above, the configured CG occasion comprises one of at least one configured CG occasion before at least one used CG occasion in the CG period.

In one embodiment, the network device as above, the UCI further comprises at least one of: a number indication or a HARQ process indication with predefined values.

In one embodiment, the network device as above, the presence indication is implicitly indicated by at least one of: the number indication, or the HARQ process indication.

In one embodiment, the network device as above, the network device is further caused to: in accordance with a determination that the presence indication indicates that no uplink shared channel is transmitted in the associated CG occasion, ignore the number indication and the HARQ process indication in the UCI.

In one embodiment, the network device as above, the configured CG occasion comprises one of at least one used CG occasion.

In one embodiment, the network device as above, the UCI further comprises at least one of: a first indication indicating a first index of a last used CG occasion among the at least one used CG occasion, a second indication indicating a second index of a first unused CG occasion after at least one used CG occasion, or a HARQ process indication indicating a HARQ process number of the configured CG occasion.

The present disclosure provides a method of communication, comprising the operations implemented at the terminal device discussed above.

The present disclosure provides a method of communication, comprising the operations implemented at the network device discussed above.

The present disclosure provides a terminal device, comprising: a processor; and a memory storing computer program codes; the memory and the computer program codes configured to, with the processor, cause the terminal device to perform the method implemented at the terminal device discussed above.

The present disclosure provides a network device, comprising: a processor; and a memory storing computer program codes; the memory and the computer program codes configured to, with the processor, cause the network device to perform the method implemented at the network device discussed above.

The present disclosure provides a computer readable medium having instructions stored thereon, the instructions, when executed by a processor of an apparatus, causing the apparatus to perform the method implemented at a terminal device or a network device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, the method comprising:
receiving, from a network device, a configured grant (CG) configuration including an indication of a periodicity; and
determining, a hybrid automatic repeat request (HARQ) process identifier (ID) associated with an uplink transmission based on the periodicity and a current symbol, wherein the current symbol is determined based on a hyper system frame number (H-SFN).

22. The method of claim 21, wherein the CG configuration indicates at least one CG occasion within the periodicity.

23. The method of claim 22, wherein determining the HARQ process ID comprises:
determining the HARQ process ID further based on a number of the at least one CG occasion.

24. The method of claim 21, wherein the periodicity is across two hyper system frames.

25. The method of claim 21, wherein the current symbol is determined based on (1024×H-SFN+SFN)×numberOfSlotsPerFrame×numberOfSymbolsPerSlot+a slot number in a frame×numberOfSymbolsPerSlot+a symbol number in a slot, wherein numberOfSlotsPerFrame refers to a total number of consecutive slots per frame, numberOfSymbolsPerSlot refers to a total number of consecutive symbols per slot.

26. A method performed by a network device, the method comprising:
transmitting, to a terminal device, a configured grant (CG) configuration including an indication of a periodicity; and
determining, a hybrid automatic repeat request (HARQ) process identifier (ID) associated with an uplink transmission based on the periodicity and a current symbol, wherein the current symbol is determined based on a hyper system frame number (H-SFN).

27. The method of claim 26, wherein the CG configuration indicates at least one CG occasion within the periodicity.

28. The method of claim 27, wherein determining the HARQ process ID comprises:
determining the HARQ process ID further based on a number of the at least one CG occasion.

29. The method of claim 26, wherein the periodicity is across two hyper system frames.

30. The method of claim 26, wherein the current symbol is determined based on (1024×H-SFN+SFN)×numberOfSlotsPerFrame×numberOfSymbolsPerSlot+a slot number in a frame×numberOfSymbolsPerSlot+a symbol number in a slot, wherein numberOfSlotsPerFrame refers to a total number of consecutive slots per frame, numberOfSymbolsPerSlot refers to a total number of consecutive symbols per slot.

31. A terminal device, comprising:
a processor configured to cause the terminal device to:
receive, from a network device, a configured grant (CG) configuration including an indication of a periodicity; and
determine, a hybrid automatic repeat request (HARQ) process identifier (ID) associated with an uplink transmission based on the periodicity and a current symbol, wherein the current symbol is determined based on a hyper system frame number (H-SFN).

32. The terminal device of claim 31, wherein the CG configuration indicates at least one CG occasion within the periodicity.

33. The terminal device of claim 32, wherein the terminal device is caused to determine the HARQ process ID by:
determining the HARQ process ID further based on a number of the at least one CG occasion.

34. The terminal device of claim 31, wherein the periodicity is across two hyper system frames.

35. The terminal device of claim 31, wherein the current symbol is determined based on (1024×H-SFN+SFN)×numberOfSlotsPerFrame×numberOfSymbolsPerSlot+a slot number in a frame×numberOfSymbolsPerSlot+a symbol number in a slot, wherein numberOfSlotsPerFrame refers to a total number of consecutive slots per frame, numberOfSymbolsPerSlot refers to a total number of consecutive symbols per slot.
